(19) United States
(12) Patent Application Publication
(10) Pub. No.: US 2005/0027594 A1
(43) Pub. Date: Feb. 3, 2005

(54) Self-service platform for selling advertising

(76) Inventors: Elliot Yasnovsky, Palo Alto, CA (US); Jayesh Bhayani, Cupertino, CA (US); Ilya N. Slain, Santa Clara, CA (US)

Correspondence Address: John Normile;Jones Day LLC, 222 East 41st Street, New York, NY, 10017-6702, US

(21) Appl. No.: 10/700,837

(22) Filed: Nov. 3, 2003

Related U.S. Application Data
(60) Provisional application No. 60/490,741, filed on Jul. 28, 2003.

(51) Int. Cl. G06F 17/60

(52) U.S. Cl. 705/14

(57) ABSTRACT

A self-service platform allows advertisers to create and manage their own ad campaigns to be run on a computer network, such as the Internet. In one variation, ads are sold on a preset price basis.

### CROSS-REFERENCE TO RELATED APPLICATION

This application claims priority under 35 U.S.C. § 119(e) to U.S. Provisional Patent Application Ser. No. 60/490,741, “Self-Service Platform For Selling Advertising,” by Elliot Yasnovsky and Jayesh Bhayani, filed Jul. 28, 2003, the contents of which are incorporated by reference herein.

### BACKGROUND OF THE INVENTION

1. Field of the Invention

This invention relates generally to a self-service platform for selling advertising, for example as can be used to sell advertising on web pages.

2. Description of the Related Art

The transfer of information over computer networks has become an increasingly important means by which institutions, corporations, and individuals do business. Computer networks have grown over the years from independent and isolated entities established to serve the needs of a single group into vast internets that interconnect disparate physical networks and allow them to function as a coordinated system. Currently, the largest computer network in existence is the Internet. The Internet is a worldwide interconnection of computer networks that communicate using a common protocol. Millions of computers, from low-end personal computers to high-end super computers, are connected to the Internet.

The Internet has evolved to serve a variety of interests and forums. In particular, the Internet is rapidly transforming into a global electronic marketplace of goods and services as well as of ideas and information. This transformation of the Internet into a global marketplace was driven in large part by the introduction of an information system known as the World Wide Web (“the web”). The web is a distributed database designed to give wide access to a large universe of documents. The database records of the web are in the form of documents known as web pages. These web pages typically reside on web servers and are accessible via the Internet. Computers connected to the Internet may access the web pages via a program known as a web browser, which has a powerful, simple-to-learn graphical user interface. One powerful technique supported by the web browser is known as hyperlinking, which permits web page authors to create links to other web pages that users can then retrieve by using simple point-and-click commands on the web browser.

Web pages may be constructed in any of a variety of formatting conventions, such as Hyper Text Markup Language (HTML), and may include multimedia information content such as graphics, audio, and moving pictures. Any person with a computer and a connection to the Internet may access any publicly accessible web page. Thus, a presence on the World Wide Web has the capability to introduce a worldwide base of consumers to businesses, individuals, and institutions seeking to advertise their products and services to potential customers. Furthermore, the ever increasing sophistication in the design of web pages, made possible by the exponential increase in data transmission rates and computer processing speeds, makes the web an increasingly attractive medium for advertising and other business purposes, as well as for the free flow of information.

The availability of powerful new tools that facilitate the development and distribution of Internet content has led to a proliferation of information, products, and services offered on the Internet and dramatic growth in the number of consumers and advertisers using the Internet. Commerce conducted over the Internet has grown and is expected to continue to grow dramatically. As a result, the Internet has emerged as an attractive new medium for businesses and advertisers of information, products and services to reach these large numbers of consumers.

In particular, small businesses, especially those that address highly targeted niche markets, may benefit substantially from advertising on the Internet (or other similar computer networks). The cost of advertising on the Internet can be relatively low compared to other media and advertisers potentially can reach a very wide audience (or a highly targeted audience). However, traditional advertising channels are not well suited to address smaller advertisers. A direct sales force cannot cost efficiently reach advertisers that want to place only a limited number of ads or that only want to spend a relatively low dollar amount on advertising.

Thus, there is a need for new approaches to advertising to address these potential advertisers.

### SUMMARY OF THE INVENTION

The present invention overcomes the limitations of the prior art by providing a computerized self-service platform that assists advertisers in creating and/or managing their own ad campaigns to be run on a computer network, such as the Internet. The self-service aspect is beneficial for publishers because it reduces the cost of sales and operations related to advertising. The self-service aspect is beneficial for advertisers because it increases operational flexibility. In one implementation, various functions can be managed directly by the advertiser at any time and in real-time or near real-time, thereby improving the speed with which advertising campaigns can be optimized. In other aspects of the invention, an automated platform assists the advertiser to create and manage advertisements, create and manage orders and/or campaigns using those advertisements, receive reports concerning the orders, and/or manage a debit account from which fees are deducted to pay for the advertisements.

In one specific approach, ads are ordered on a preset price basis. The price of the ad may be set by the seller at any time prior to when the advertiser orders. For example, the ad price may be based on a fixed cost per click (CPC), where the advertiser agrees to pay a specific dollar amount (i.e., the cost-per-click) each time the advertisement is clicked on. The CPC may vary over time (e.g., different CPC for the days before Christmas versus the days after Christmas), but the CPC is set by the time the advertiser orders. Advertisers who order the same placement compete on the basis of relevancy, as may be measured in some cases by effective CPM rate or by click-through rate. For example, assume that 100 advertisers order ads for placement on the Yahoo! Finance front page, at a location that can only show 3 ads at a time. The ads with the highest effective CPM (eCPM) rate are given priority for placement on the page. The eCPM can be calculated for example as eCPM=CPC*CTR*1000, where CTR is the click-through rate. If all 100 ads are ordered at the same cost per click, then the ads with the highest click-through rates will receive priority. This is merely an example. Other pricing and priority models can also be used.

Other aspects of the invention include systems and methods for implementing the advertising models described above.

### BRIEF DESCRIPTION OF THE DRAWING

The invention has other advantages and features which will be more readily apparent from the following detailed description of the invention and the appended claims, when taken in conjunction with the accompanying drawing, in which:

FIG. 1 is a block diagram of an example system suitable for use with the present invention.

FIG. 2 is a graphical depiction of a web page for logging into a self-service platform for managing advertising.

FIGS. 3A-3D are graphical depictions of web pages for creating an ad campaign.

FIGS. 4A-4F are graphical depictions of web pages for managing an ad campaign.

FIGS. 5A-5D are graphical depictions of web pages for funding an account.

FIGS. 6A-6E are graphical depictions of web pages for creating and managing campaigns and ads.

FIG. 7 is a graphical depiction of a web page for setting alerts.

FIG. 8 is a block diagram illustrating billing for an example system with a self-service platform.

FIG. 9 is a block diagram illustrating more detail of the self-serve billing module of FIG. 8.

FIG. 10 is a data flow diagram illustrating UI-driven on-line payment to an account.

FIG. 11 is a data flow diagram illustrating offline payment to an account.

FIGS. 12A-12B are data flow diagrams illustrating credit-card based automatic and monthly refill billing models, respectively.

FIG. 13 is a data flow diagram illustrating a recurrent billing model with offline payment.

FIG. 14 is a block diagram illustrating transactional updates for the system of FIG. 8.

FIG. 15 is a state diagram showing line status transitions.

FIG. 16 is a state diagram showing ad status transitions.

FIG. 17 is a block diagram illustrating log aggregation for the system of FIG. 8.

FIG. 18 is a block diagram showing further details of the log aggregation module of FIG. 17.

FIG. 19 is a block diagram illustrating reports for the system of FIG. 8.

### DETAILED DESCRIPTION OF THE PREFERRED EMBODIMENTS

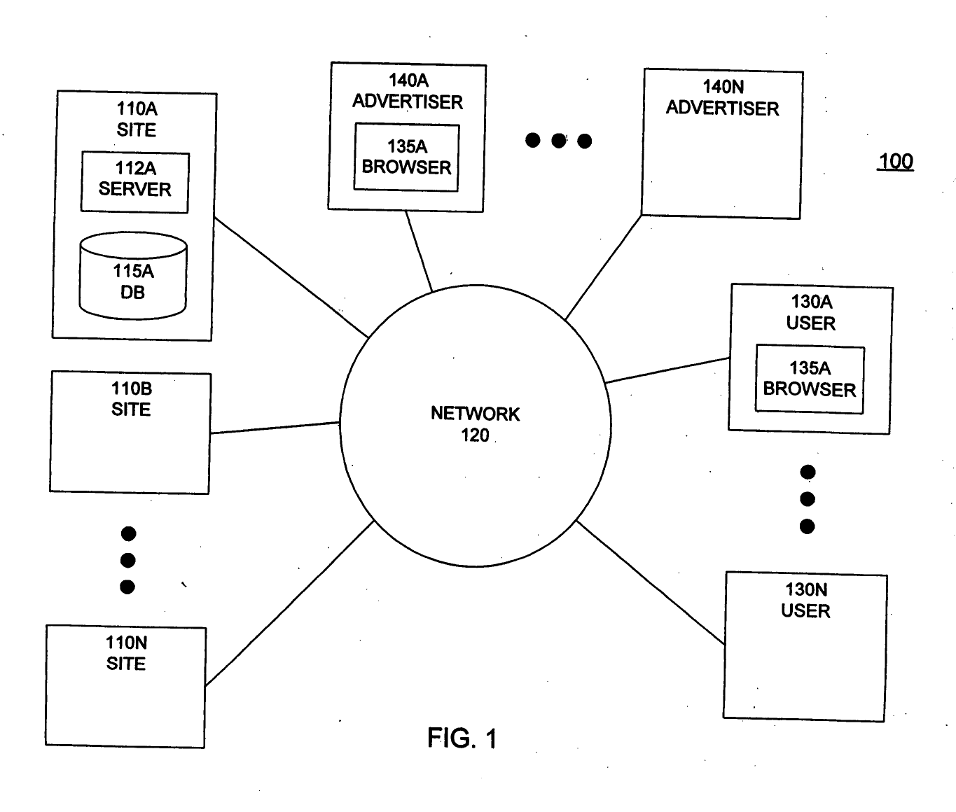

FIG. 1 is a block diagram of an example system 100 suitable for use with the present invention. Generally speaking, the system 100 includes a number of sites 110A-N, users 130A-N and advertisers 140A-N that communicate with each other over a network 120. The sites 110 provide pages to the users 130. The advertisers 140 order advertising on the sites 110 via a self-service platform, which can be implemented as part of a site 110.

In one specific embodiment, the network 120 is the Internet. The sites 110 include web sites, such as Yahoo!'s various properties: the Yahoo! Main Page, Launch!, News, Finance, etc. The users 130 include individuals who access the Internet, typically by web browsers 135 such as Netscape's Navigator or Microsoft's Internet Explorer. The advertisers 140 are entities that wish to places ads on web pages on the Yahoo! sites. They also typically access the self-service platform (implemented as sites 110) by web browsers 135. In some cases, the users 130 and advertisers 140 can access the sites 110 using other means, for example by software agents or programmatic interfaces.

The sites 110 transmit web pages to the users 130 in response to their requests. The web pages include advertising that was ordered by the advertisers 140. A typical site architecture is shown in simplified form in 110A. A web server 112 provides an interface to the Internet and a database 115 contains information about the different components (e.g., content and ads) used to compose pages. The components themselves may or may not be included as part of the database 115.

FIG. 1 is simplified for clarity. For example, the sites 110, users 130 and advertisers 140 are shown as separate entities. In fact, the same entity may play one or more roles. Entities may also take on different roles in different contexts. In addition, the different roles can be distributed and/or divided among many different entities. For example, in order to compose and serve a page to a user 130, a site 110 may request an article from another site, obtain ads from a third party ad server, and obtain some graphics and links from its internal database. The ads may be ordered via yet another site for inclusion in the web pages served by site 110. The site 110 itself may also be distributed for redundancy and/or performance reasons. For example, large sites such as the Yahoo! sites typically run different web properties from different servers and use an architecture that is more sophisticated than that shown in FIG. 1, using for example multiple servers, databases, load balancers, etc.

As further clarification, although the Internet will be used as the primary example in this disclosure, the invention can be used with other systems also. For example, the entities 110, 130 and 140 may communicate with each other over separate communications networks, private or proprietary networks or dedicated communications channels, rather than through the common network 120 of FIG. 1. Alternately, various parts of system 100 may be implemented by mobile components and may not be permanently attached to a communications network. For example, entities may interact with each other via a wireless connection. As a final example, the pages can be based on protocols other than the web, for example protocols used with wireless networks or proprietary protocols for proprietary networks.

Turning now to pricing, in one approach, the ads are ordered on a preset price basis. The price of the ad is set by the seller, and it is set by the time that the ad is ordered. For example, the price of a certain size and location ad on the Yahoo! front page at a certain time may be set at $x per click-through. There are many permutations of this preset price model. For example, the price may vary as a function of the ad's size, the ad's location on the page, the specific page, the time when the ad will run, the demand for the ad spot, etc. The price can be defined by a definite formula, as opposed to a specific dollar figure. The price can also vary as a function of when the order is placed, although it will be set at the time of ordering. For example, if the demand for a particular ad spot is low, then the price quoted at that time may be relatively low. If the advertiser returns at a later time, the price quoted for the same ad spot may be higher due to increased demand for that ad spot. Prices can be updated in real-time or near real-time. The price can also be expressed in different ways: per impression, per click-through, per converted purchase, etc. Other pricing models can also be used. For example, pricing can be based on bidding models, or a mixture of bidding and preset price models.

Different pricing models can be directly compared by reducing the pricing to a common measure, for example the effective cost per thousand impressions (the eCPM). For fixed price of $x per impression, the eCPM=$x*1000. For a bid price of $x per click-through, the eCPM $x*click-through-rate*1000.

The types of ads can also vary. Examples include text only, text+link, icon+link, banner ads, graphics, video, etc. The media on which the ad runs can also vary. Common examples include ads that run on web pages, ads that run as the result of searches, and ads that run on wireless devices. An ad for a brokerage house placed on the Yahoo! Finance front page is an example of the first. An ad for a brokerage house that runs as the result of a search for “stocks” is an example of the second. An ad for a fast food restaurant that runs as the result of a promixity-based restaurant lookup on a wireless device is an example of the third.

Once ads are ordered, the selection of which ads appear in which locations on which pages can also occur in many different ways. For example, assume that 100 ads are ordered for placement on the Yahoo! Finance front page, at a location that can only show three ads at a time. In one approach, three of the 100 ads can be selected at random, or the ads can be displayed in rotation. Alternately, priority can be given to ads that have higher relevancy. Relevancy can be measured by contextual means (e.g., using search-engine type technology). Alternately, relevancy can be measured by calculating the effective CPM (eCPM) rate, or some other financial measure. If ad 1 pays a price of $1.00 per click-through and has a click-through rate of 4%, it has an eCPM (equivalent cost-per-thousand impressions) of $40.00. If ad 2 pays the same $1.00 price but has a click-through rate of 0.1%, its eCPM is only $1.00. If ad 3 pays a price of $0.10 per click-through and has a click-through rate of 1%, its eCPM will also be $1.00. Other measures of relevancy, for example combining contextual and financial measures, can also be used.

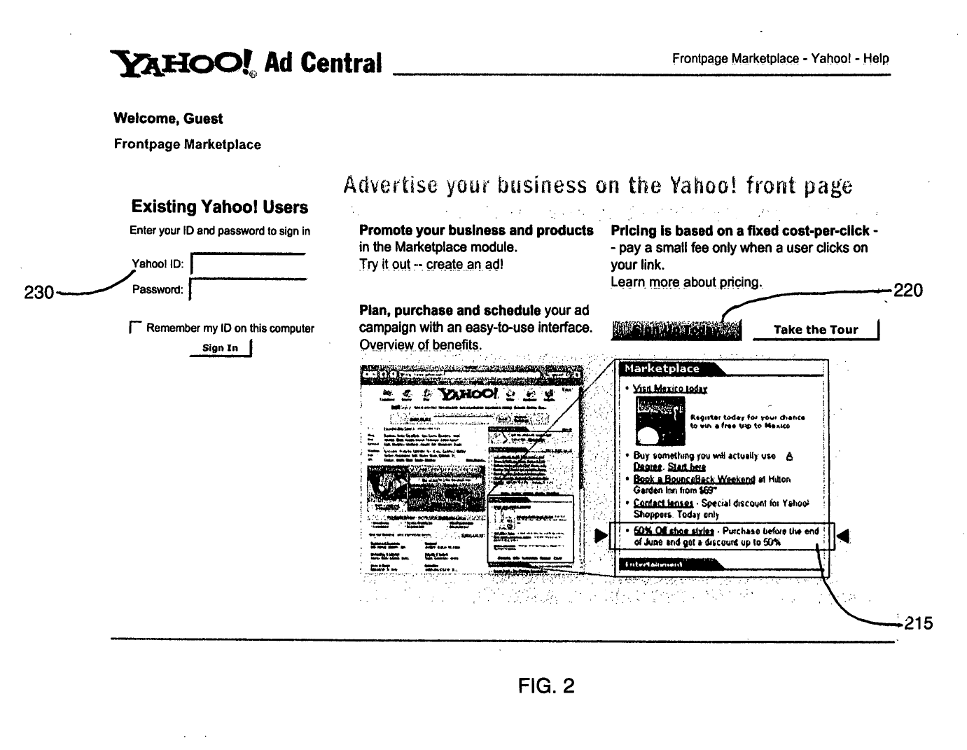

FIGS. 2-7 are graphical depictions of screen shots that illustrate a self-service platform for ads. This self-service platform allows advertisers 140 to order ads and to set up and manage ad campaigns for themselves. This particular example is in the context of ads to be placed in the Marketplace section of the Yahoo! Front Page, but the invention is not limited to this specific application. In the example of FIGS. 2-7, the self-service platform is referred to as Ad Central, which is located on a Yahoo! site. In an alternate implementation, the self-service platform is located on a site run by a different entity (e.g., a service provider to Yahoo!). Alternately, the self-service platform can sell ads for many different sites, not just Yahoo! sites.

The self-service aspect is especially beneficial for smaller advertisers. A sales force can service large advertisers but it often is not cost-effective to use a sales force to reach smaller advertisers. The self-service aspect reduces the sales cost by allowing smaller advertisers to help themselves. In the following example, the advertiser can create and manage ads, create and manage campaigns using those ads, receive and view reports on the campaigns and maintain his account balance for his campaigns. In this example, campaigns are prepaid. The advertiser prepays a certain amount in his account. As ads run, debits are generated against the prepayment, drawing down the prepayment. The self-service aspect also allows the advertiser to more easily and more immediately change his ads and campaigns. If the overall system is real-time or near real-time, as is the case in this example, any changes will take effect immediately or near-immediately.

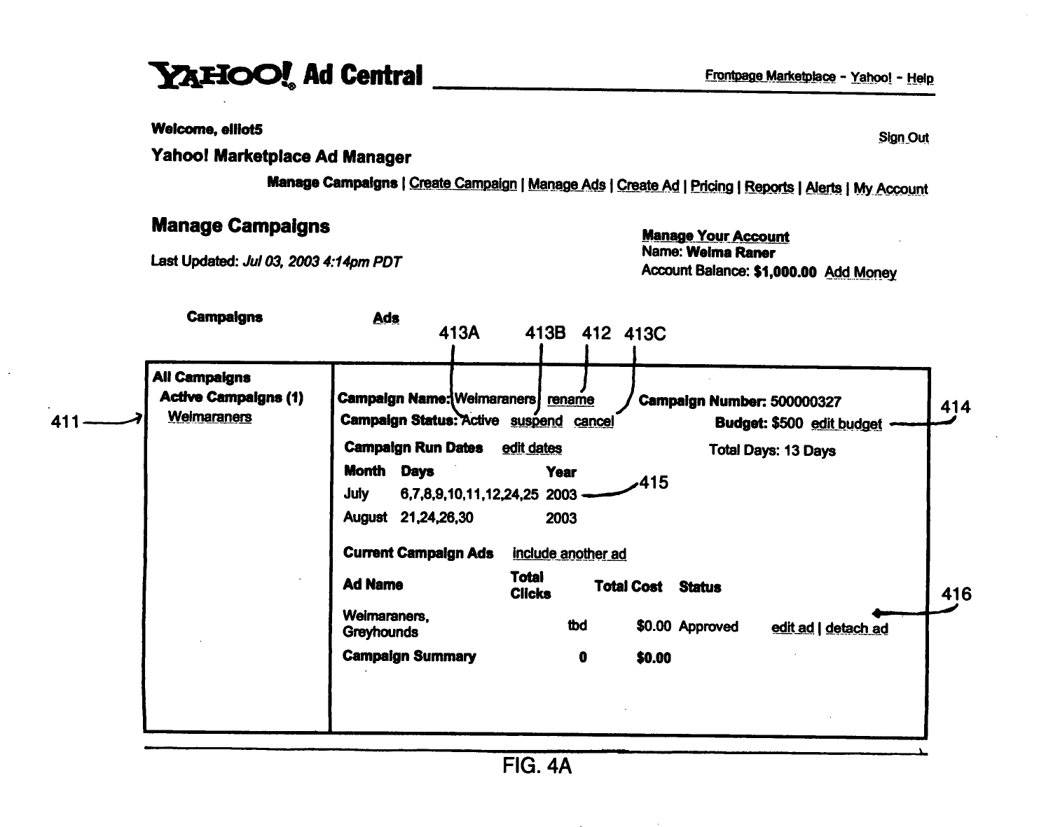

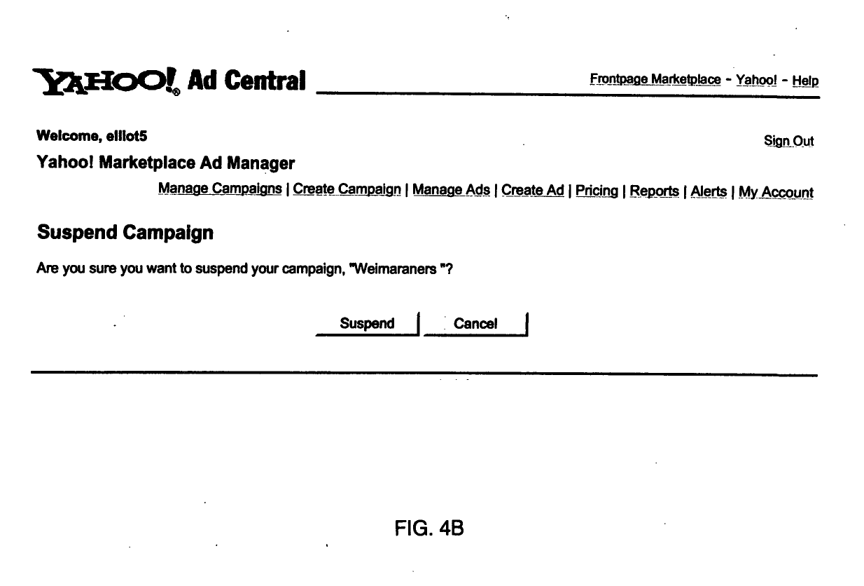

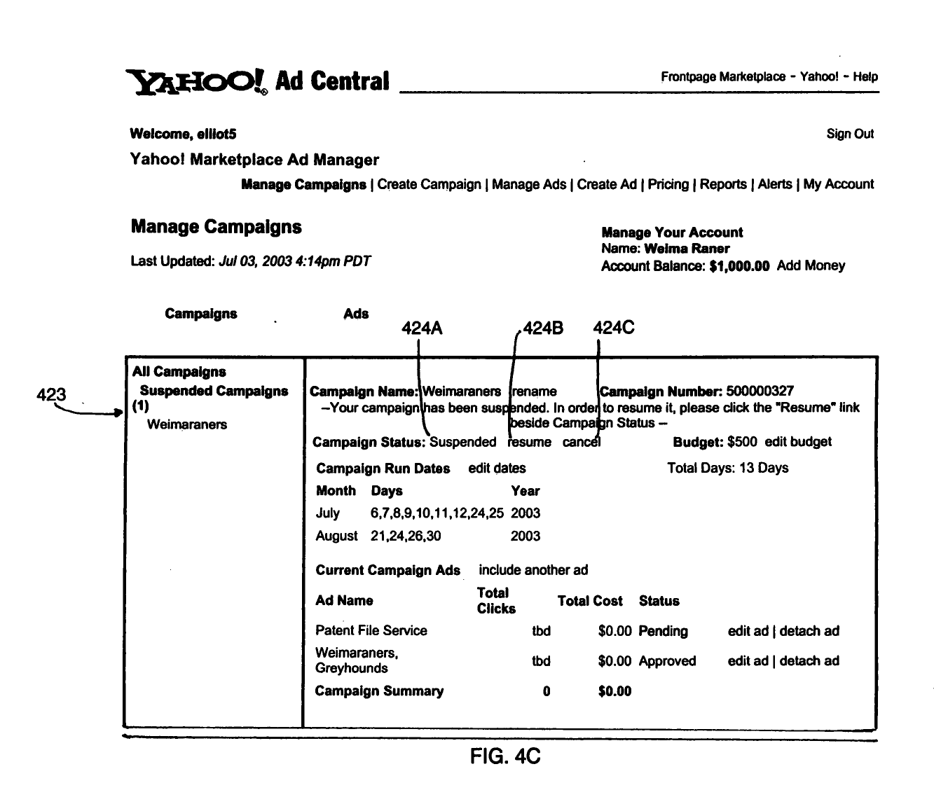

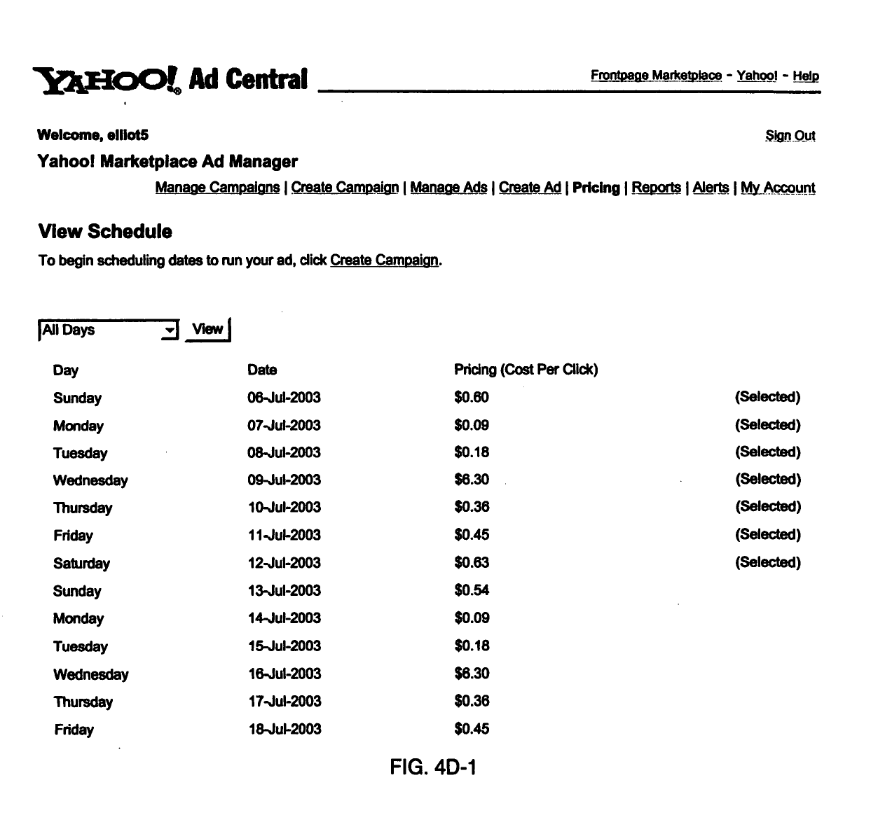

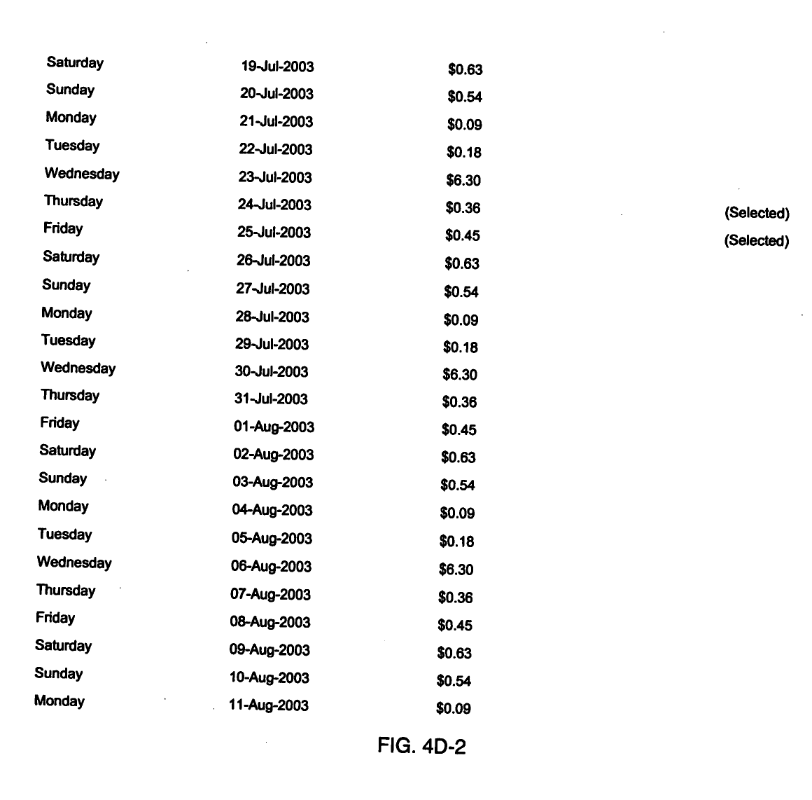

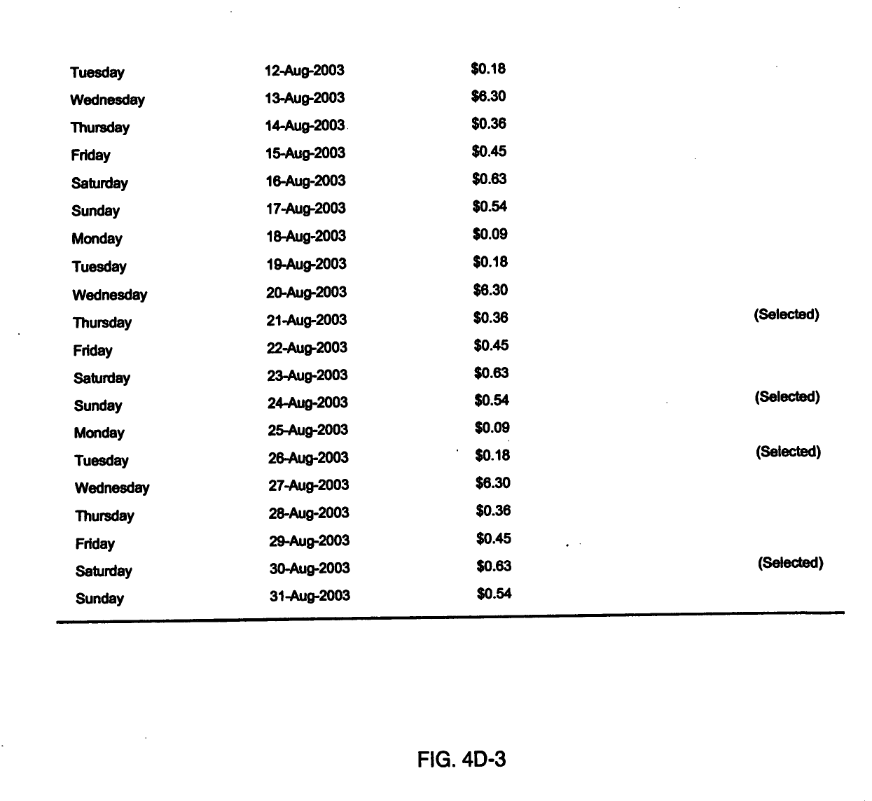

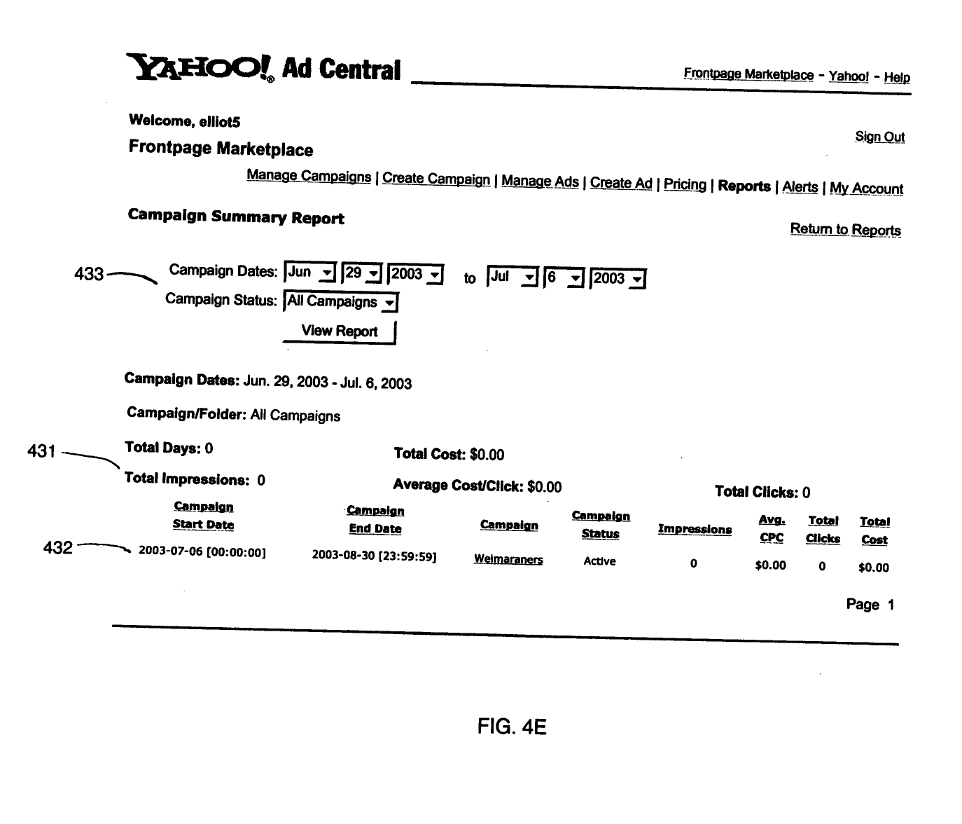

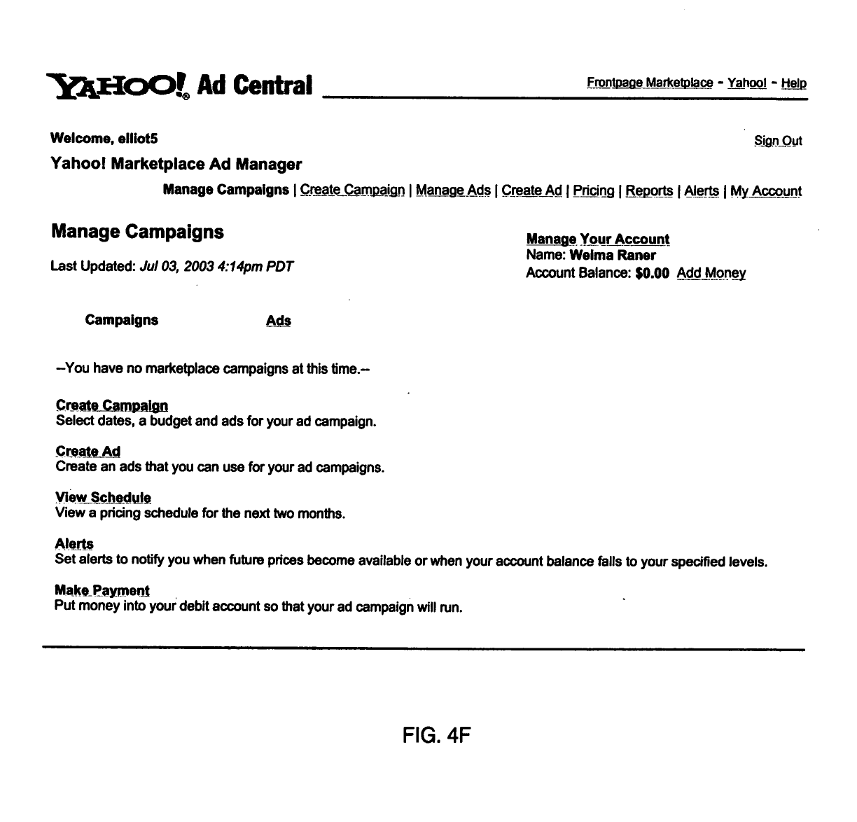

FIG. 2 shows a login page for Ad Central—Front Page Marketplace. The righthand side 210 of the page provides information about the self-service platform, including a free trial, an overview of benefits, information about pricing, a tour of the overall process and a sample ad 215. The “Sign Up Today” button 220 begins the process of creating an account for an advertiser. Existing users can log in via the lefthand side 230 of the page. Once the advertiser logs in (and/or creates his account), he can perform a number of different functions to create and manage ads and campaigns. FIG. 4A is the page returned after the advertiser logs in.

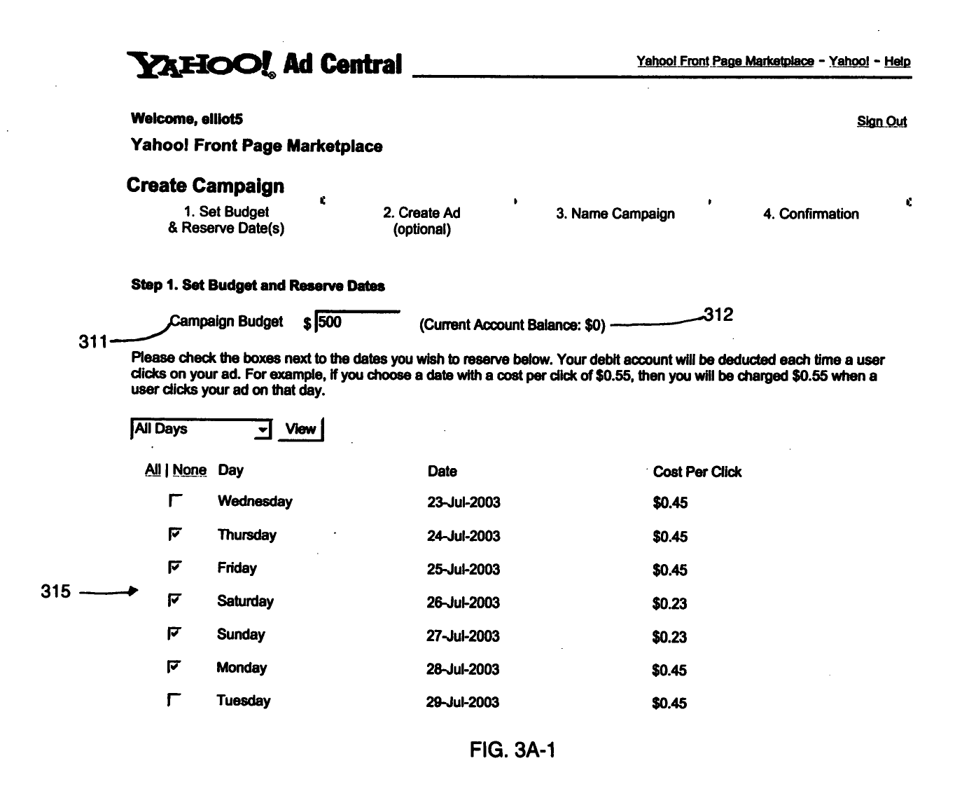

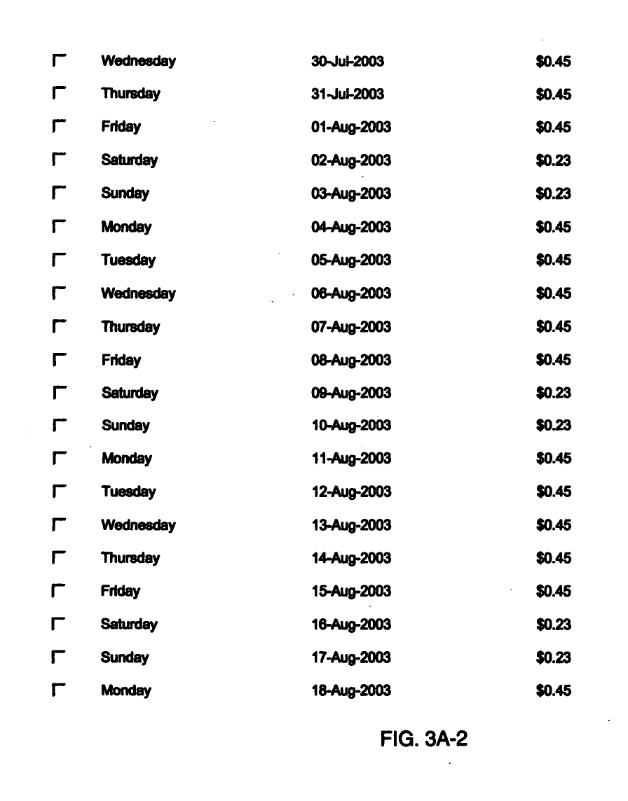

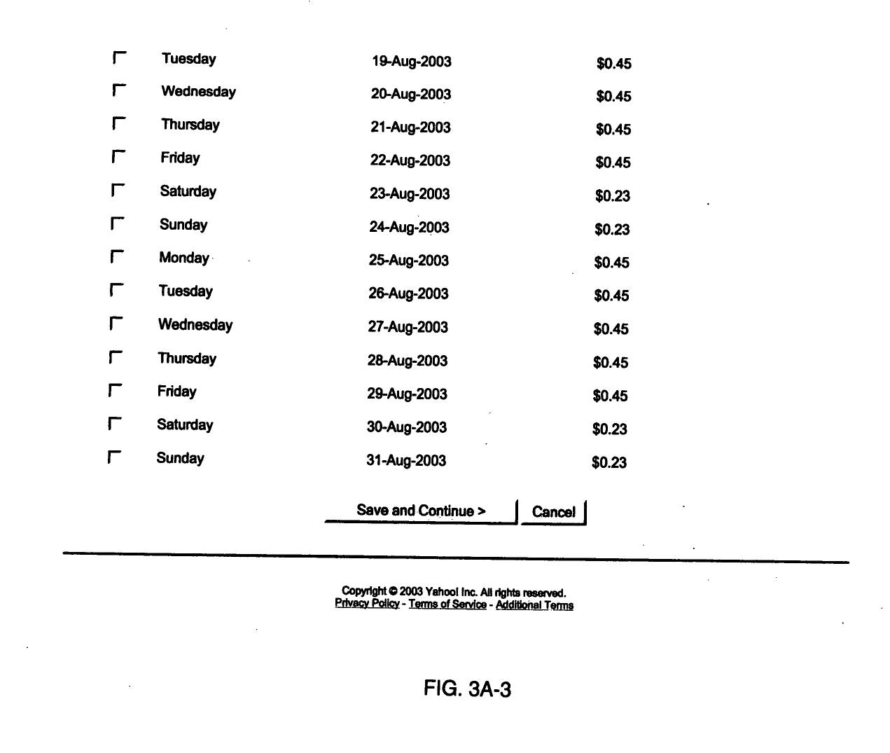

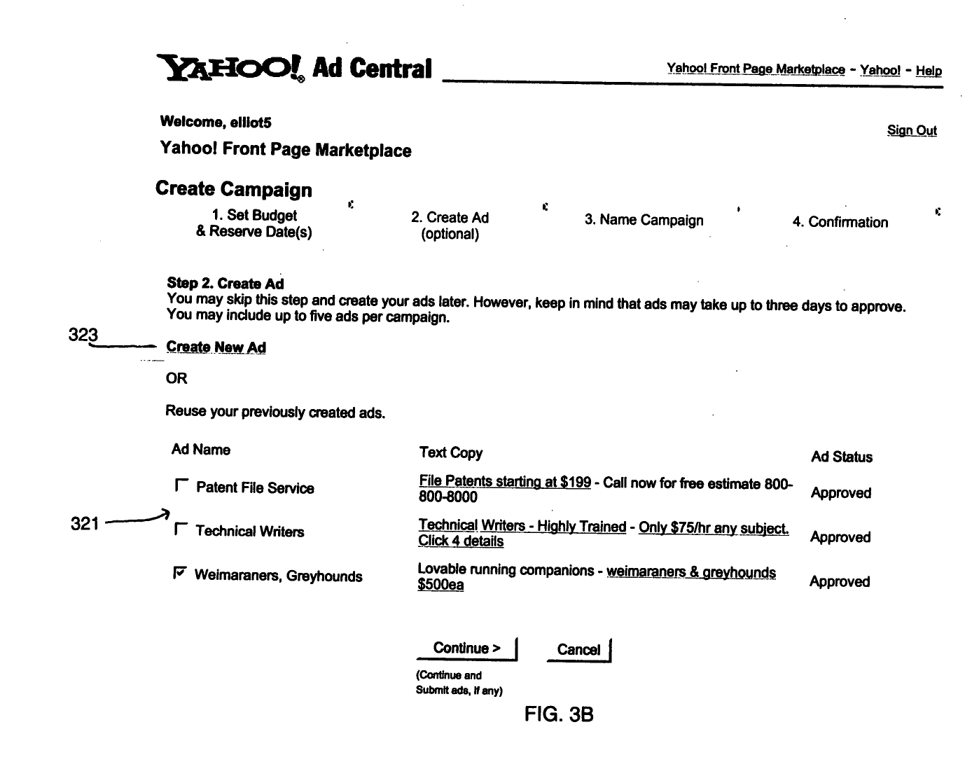

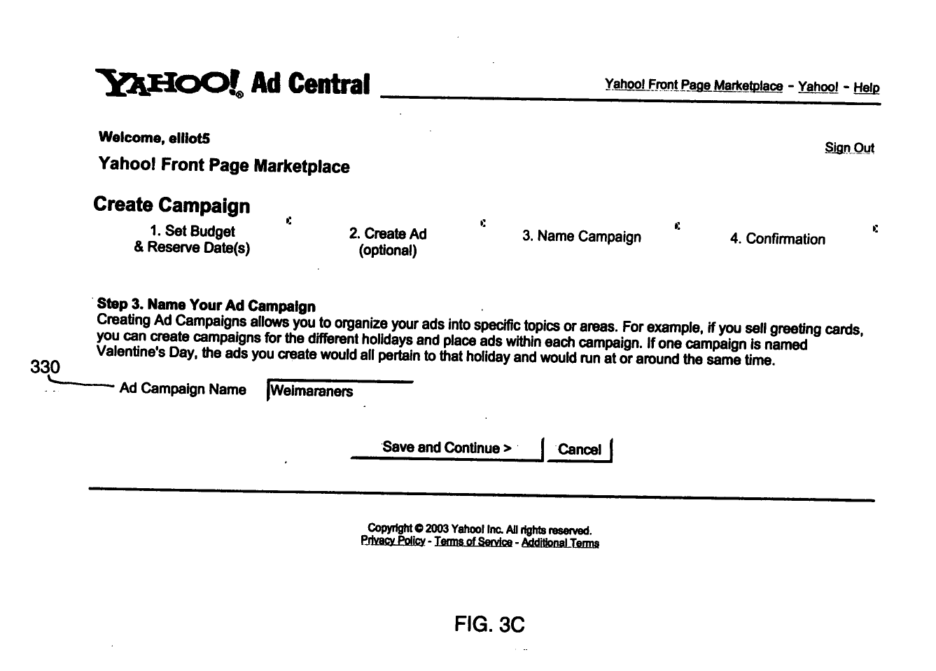

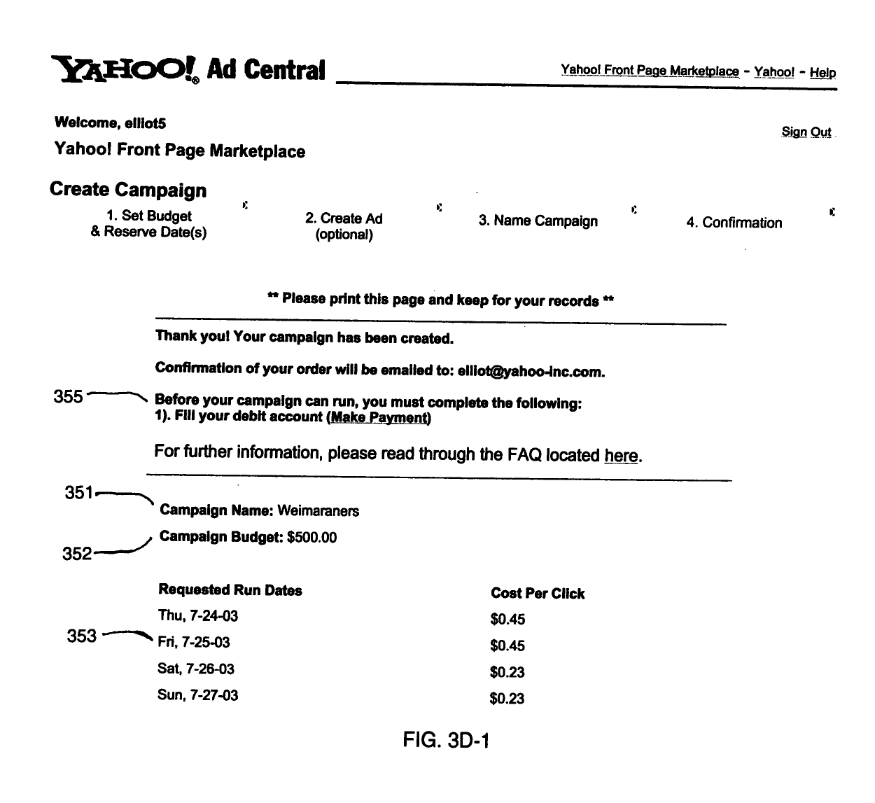

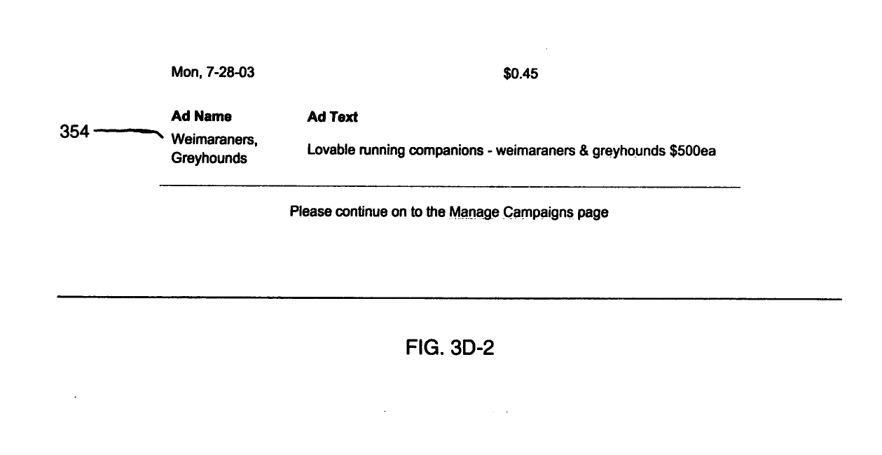

FIGS. 3A-3D show pages for creating a campaign. In FIG. 3A, the advertiser defines the campaign. In this example, he sets the campaign budget 311 to $500. The campaign budget is the maximum amount to be spent on this campaign. Note that the advertiser's current account balance 312 is $0, so the campaign will not start until the account is funded. The list of days 315 occupying the bottom of the page show which days are available for the campaign (note that the advertiser has selected to view All Days), and the CPC for each day. The CPC is set by the site. The advertiser specifies which days the campaign will run by checking the appropriate boxes on the lefthand side. In this example, there is no need to specify on which site or web page the campaign will run, because the page shown in FIG. 3A is specifically for placement on the Front Page Marketplace.

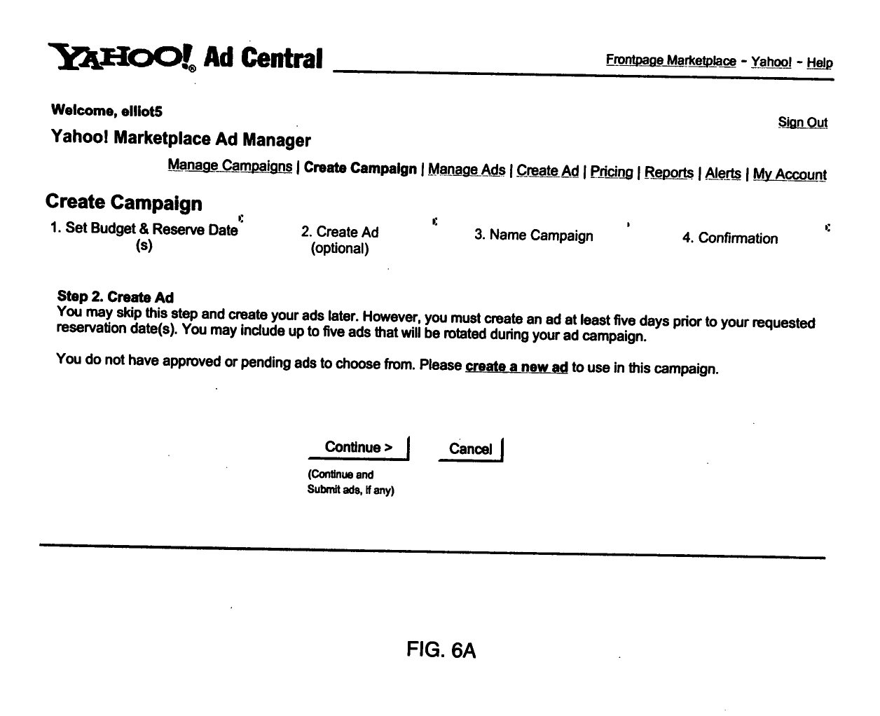

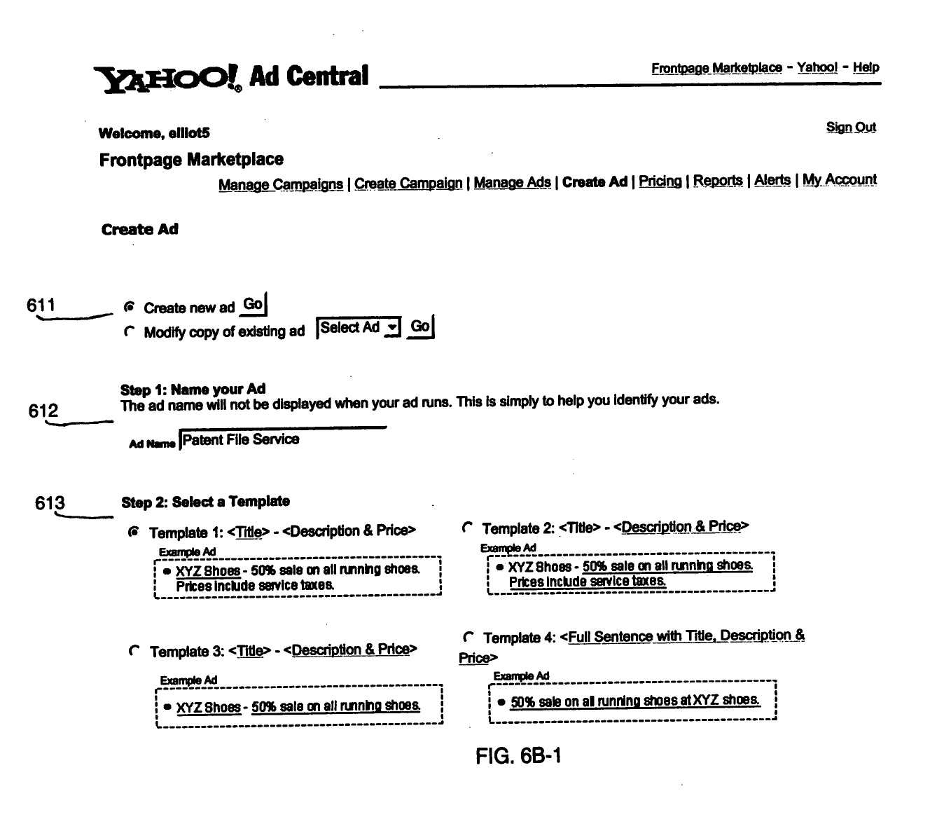

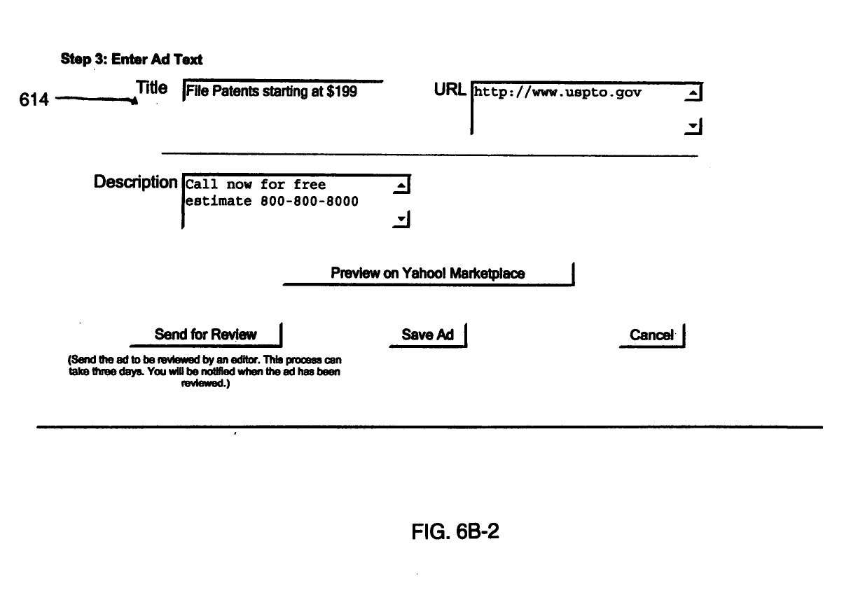

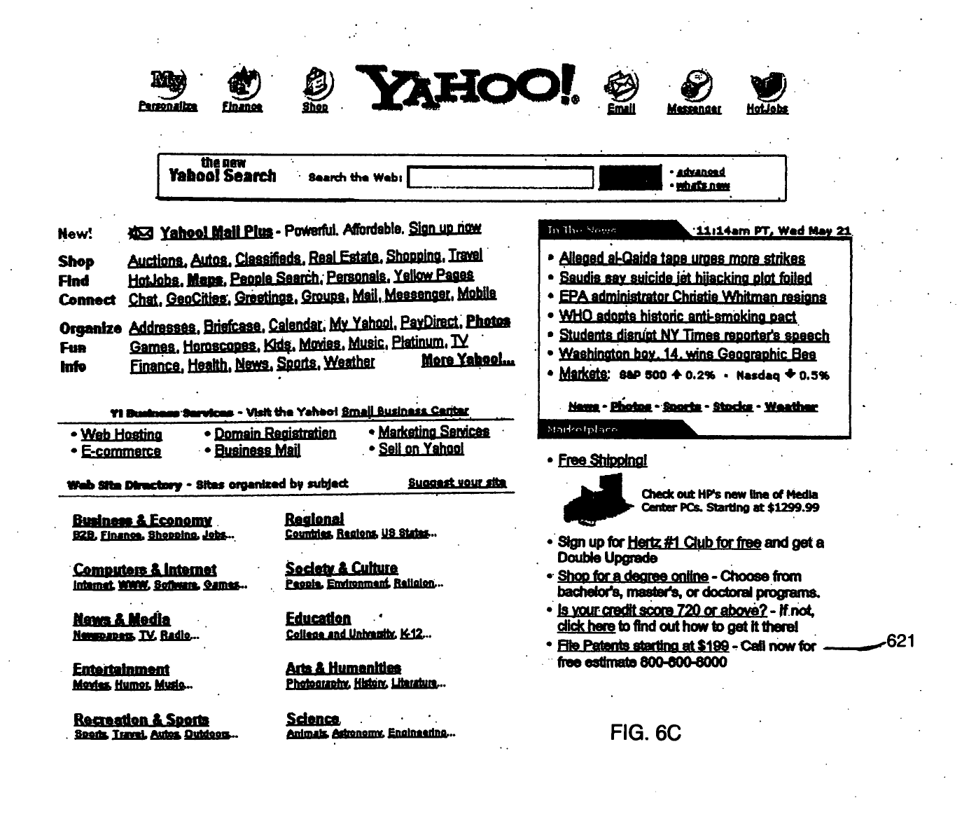

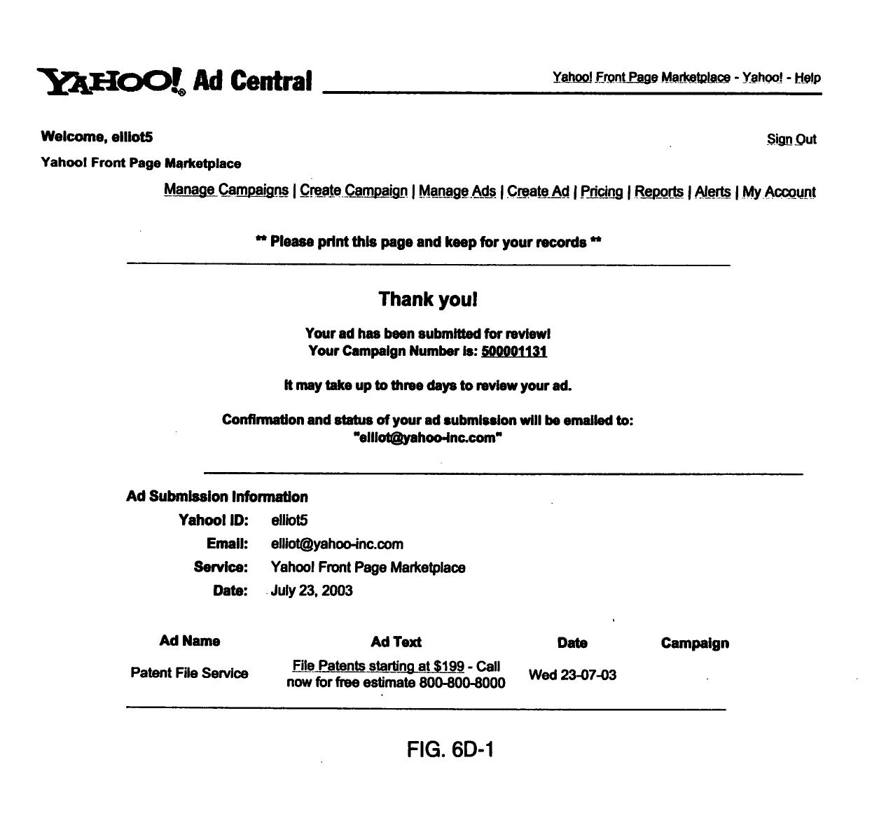

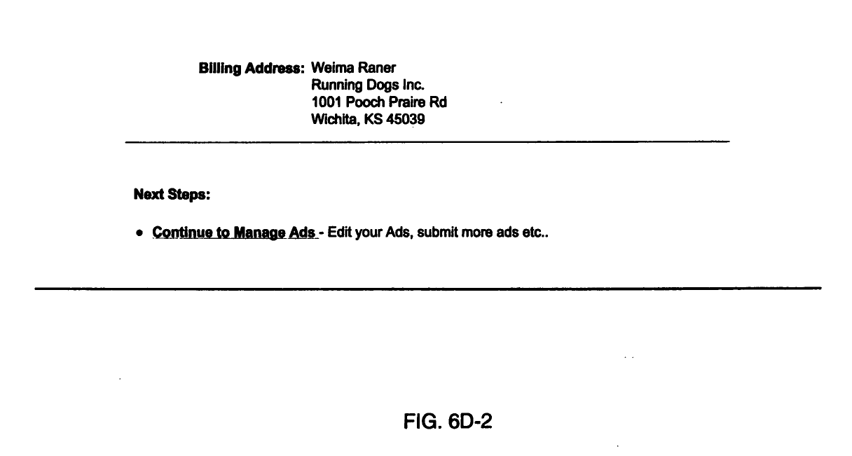

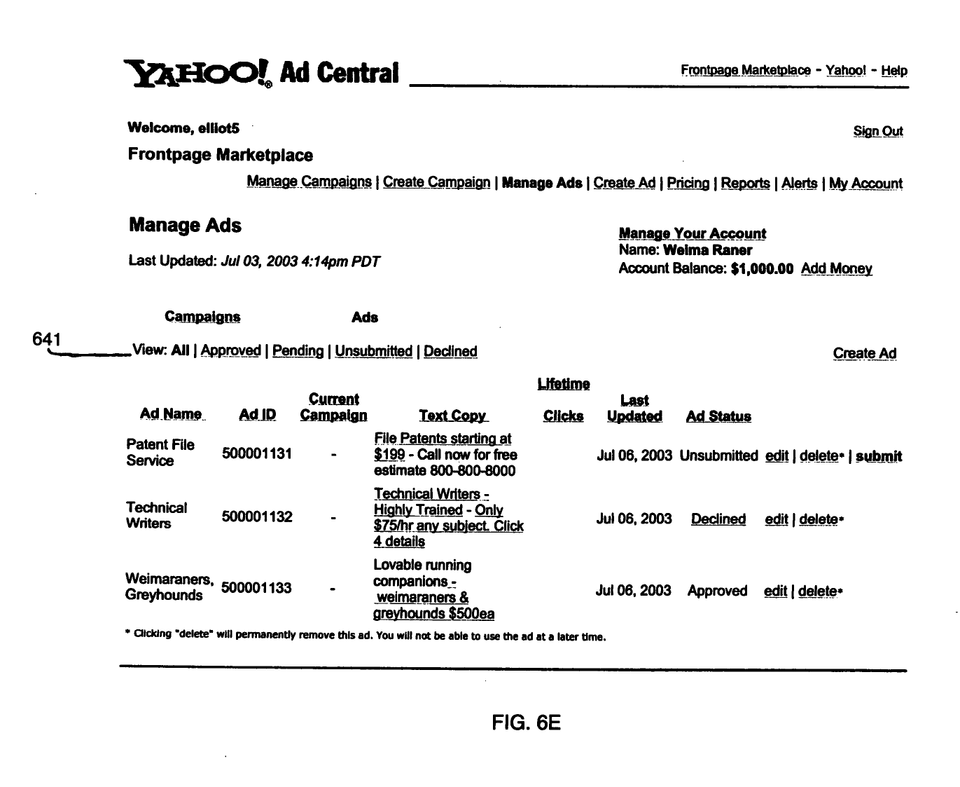

In FIG. 3B, the advertiser selects which ads will run in this campaign. Previously created ads 321 are listed by name and text copy. The “Ad Status” column indicates the status of the ads, as will be further discussed below. This example assumes that the three ads listed have been previously approved and are therefore available for use in the campaign. The advertiser checks the boxes on the lefthand side to indicate which ads will be used in this campaign. The advertiser can also create new ads 323 for his campaign, as will be illustrated in FIG. 6.

In FIG. 3C, the advertiser selects a name 330 for the campaign. FIG. 3D is a confirmation of the campaign. This confirmation lists the campaign name 351, campaign budget, 352, run dates with corresponding CPC 353, and the ads 354 in the campaign. The confirmation also includes an alert 355 to the advertiser that his account must be funded before the campaign can run. A separate confirmation with the same information is also sent by email to the advertiser.

FIGS. 4A-4F show pages for managing campaigns. FIG. 4A shows a summary of all campaigns. Currently, this user only has one active campaign and no inactive campaigns. The one active campaign is a “Weimaraners” campaign 411 (but revised relative to the Weimaraners campaign created in FIG. 3). Different management functions can be performed. Beginning at the top of the summary information for the Weimaraners campaign, the campaign can be renamed 412. The campaign status is currently Active 413A (note that the account has been funded to $1000), but the advertiser can change the status to Suspended 413B (which suspends the campaign until it is reactivated) or Cancelled 413C (which ends the campaign). The advertiser can also edit any of the following: the campaign budget 414, the run dates 415 of the campaign, and which ads 416 are used in the campaign. The ads themselves can also be edited 416. Note that the advertiser can make these edits at any time via the self-service platform. If the architecture is real-time or near real-time, then these edits will result in updates to the ad orders in real-time or near real-time.

FIGS. 4B-4C show an example of suspending a campaign. FIG. 4B requests confirmation 421 before suspending the campaign. FIG. 4C shows the “Manage Campaigns” page after the “Weimaraners” campaign has been suspended. The campaign is now listed under the Suspended Campaigns 423. The status is now listed as Suspended 424A. The advertiser can either Resume 424B the campaign (making it active again) or Cancel 424C it. Also note that the “Patent File Service” ad was added to the campaign before suspension. This ad is “Pending,” meaning that it is not yet approved for general use in campaigns, as will be further described below.

FIG. 4D shows dates, pricing and which dates are currently selected for a campaign. This page can be useful for deciding whether to edit the run dates for a campaign.

FIG. 4E shows a page with summary report information for an advertiser's campaigns. The bottom part of the page lists a summary of all of the advertiser's campaigns in the selected campaign folder (which is All Campaigns in this example). This information includes 431 total days run, total cost, total impressions and average CPC across all campaigns. It also includes 432 campaign start date, campaign end date, campaign (name), campaign status, number of impressions, average CPC, number of clicks, and total cost for each campaign. The top portion 433 allows the advertiser to view more specific reports. In this case, by clicking “View Report,” the advertiser will view a report for all of his campaigns for the dates Jun. 29, 2003 and Jul. 6, 2003.

FIG. 4F shows the “Manage Campaigns” page when there are no campaigns. Compare this page to the “Manage Campaign” pages shown in FIGS. 4A and 4C.

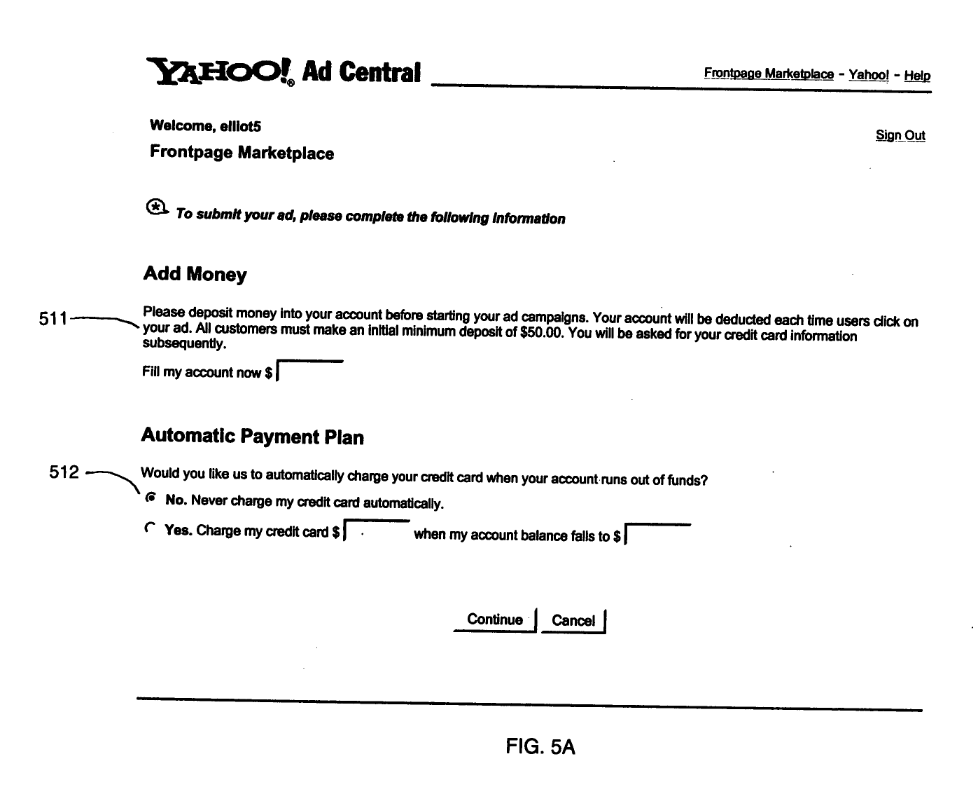

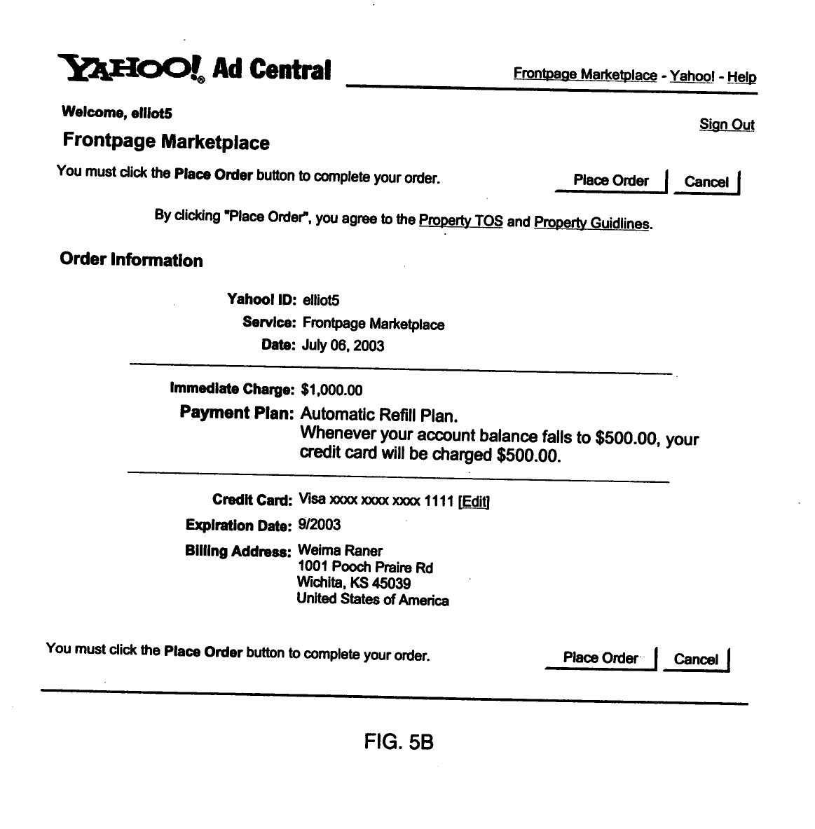

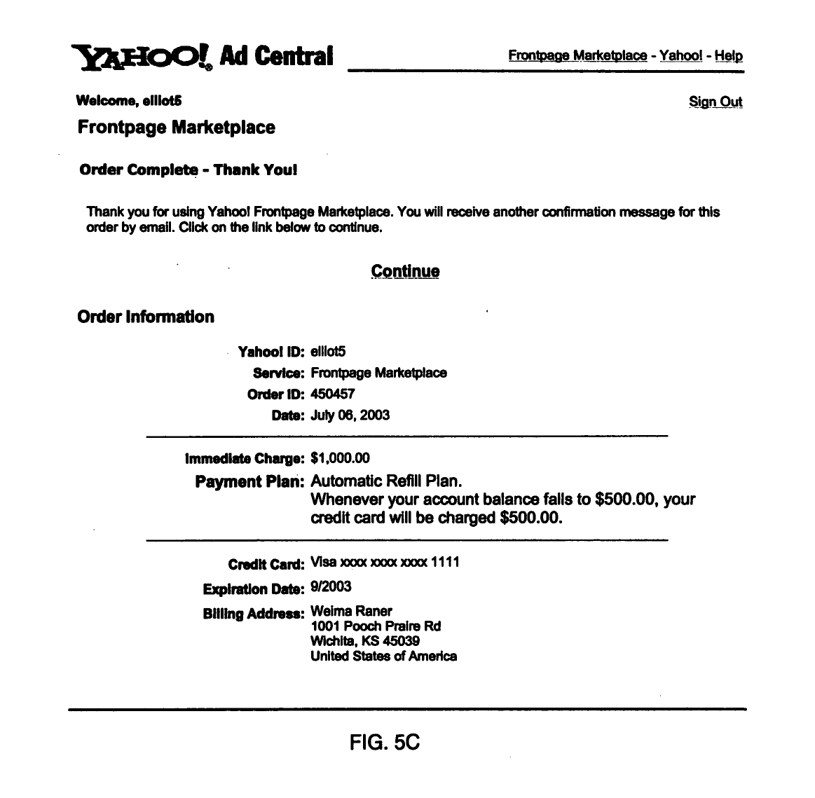

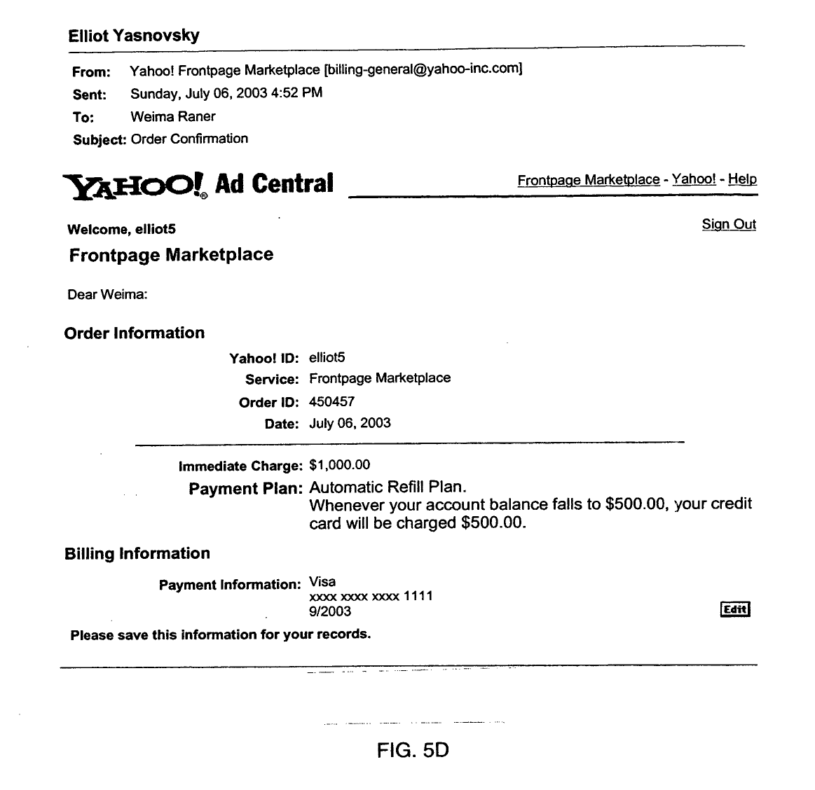

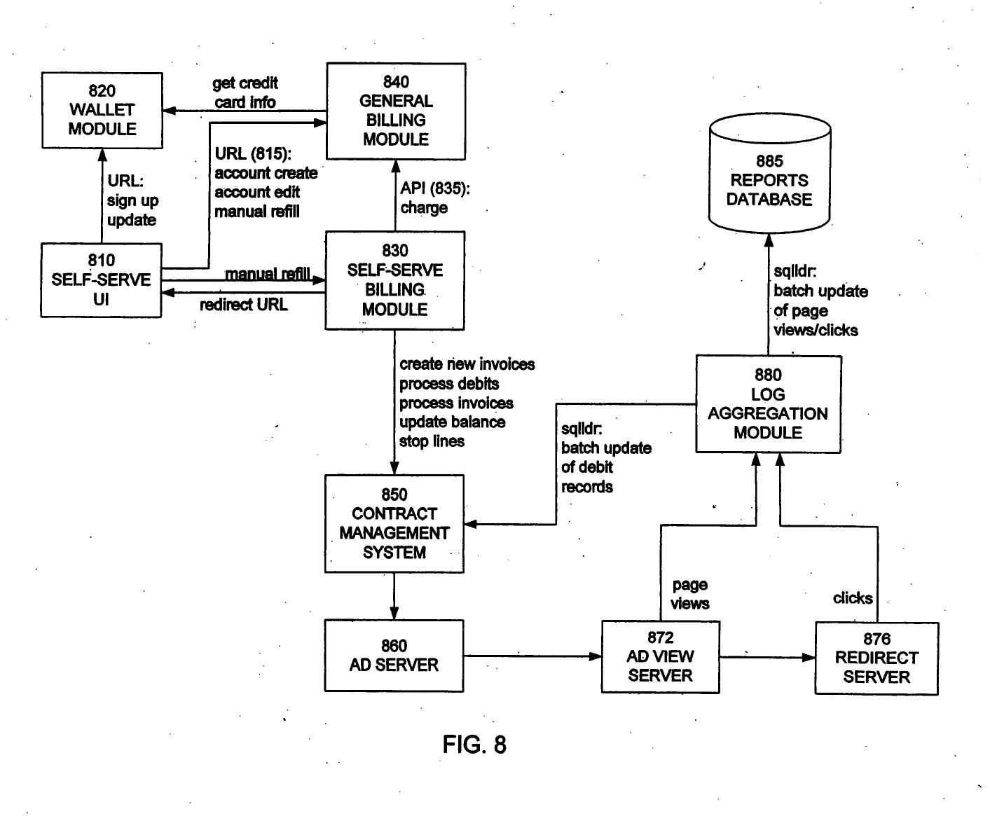

FIGS. 5A-5D show pages and emails for prepaying an account. In the example of FIG. 5A, the advertiser is asked to make an initial deposit 511 to his account. He then has two options 512 for further funding. If he wants to manually refill his account each time, he can select No for the automatic payment plan. In this example, when the accounts falls below a threshold level, an alert is generated to remind the advertiser to refill his account. Alternately, he can automatically refill his account when it falls below a threshold level. FIG. 5B requests final advertiser approval before charging the credit card. In this example, the advertiser has selected to purchase $1000 now and to automatically purchase another $500 whenever the account balance falls to $500 or below. FIG. 5C is the corresponding confirmation. FIG. 5D is a separate email confirmation for the same transaction. Purchases can also be made using wallet technology, or by other means, as will be explained in greater detail in FIGS. 8-13.

FIGS. 6A-6E show pages for creating and managing ads. In the example of FIG. 3, it was assumed that ads were already available for use in the campaign. Therefore, step 2 (Create Ad) was skipped in that example. FIG. 6 run through this step. The advertiser makes selections in FIG. 6B to create an ad. In this example, the advertiser chooses to create a new ad 611 (rather than modify an existing one). He names his ad 612 “Patent File Service” and selects one of the four available templates 613. The format of the ad is specified by the template. The templates use certain information supplied by the advertiser. For example, template 1 uses a title (“XYZ Shoes” in the template), a description (“50% sale on all running shoes. Prices include service taxes.”) and a URL to link to. In template 1, clicking on the title links to the URL. The advertiser supplies 614 this information as shown, and the ad is created based on the supplied information. FIG. 6C shows a preview 621 of the ad.

FIG. 6D shows submission of the ad. In this example system, ads are not automatically available for use in campaigns. Rather, they must be reviewed and approved first. “Pending” ads are ones that have been submitted for review but have not yet been approved. “Approved” ads have been approved and can be used in campaigns. The approval process can be manual, automated or a combination of the two. For example, automated tools can be used to search for “problem” words, phrases, or URLs. Tools can also be used to help manage the approval process.

FIG. 6E shows a page for managing different ads. In this example, the advertiser has selected 641 to view all ads. In the status column, “Unsubmitted” ads have not been submitted by the advertiser yet. “Declined” ads have been submitted but were rejected. They cannot be used in campaigns.

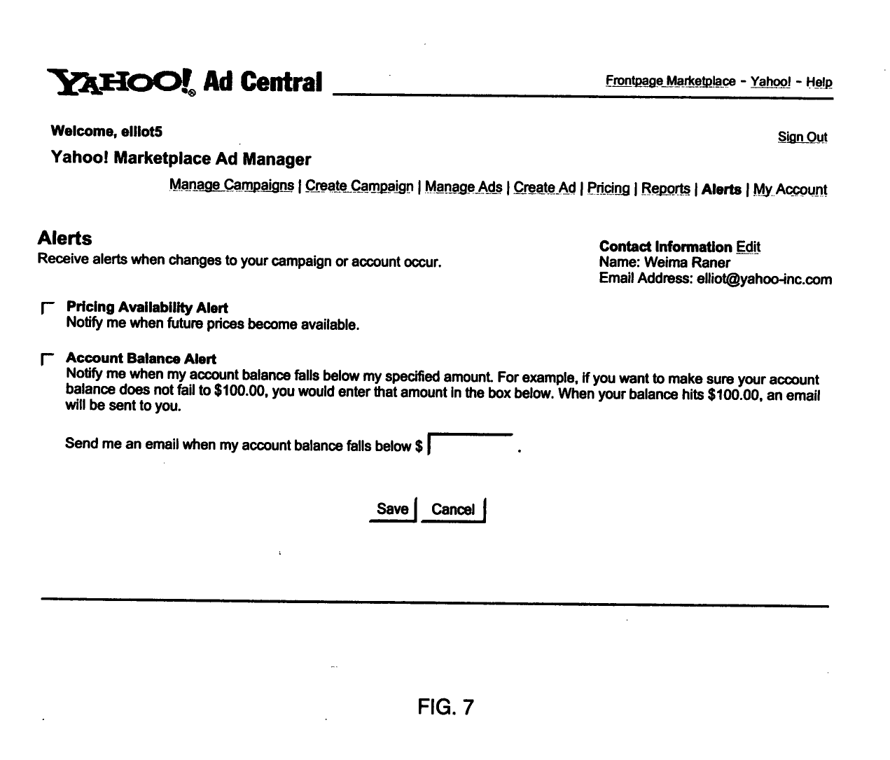

FIG. 7 shows a page for setting alerts. In this example, there are two possible alerts. One alert is generated when pricing for additional days becomes available. The other alert is generated when the advertiser's account balance falls below a certain level.

FIGS. 2-7 illustrate a specific example of a self-service platform. Many other variations will be apparent. For example, time periods other than daily and pricing models other than a fixed CPC for each day can be used. Many alternative pricing models were discussed previously. Some examples include CPM pricing, pricing determined by formula, variable pricing set by market demand (e.g., auction or bidding), preset pricing based on market demand, fixed CPC pricing that changes on a basis other than daily, pricing that takes into account relevancy, and time-based pricing (i.e., pricing based on time period of the campaign rather than number of clicks or impressions).

Placements can also vary. The example of FIGS. 2-7 was for a specific placement—a particular location on a particular page. Alternate embodiments can include different locations on the same page and/or placement on different pages or sites. As another example, ad campaigns can also include multiple types of ads, including ads not based on templates. Ads can also be placed on different types of devices, for example cell phones, PDAs and home entertainment computers in addition to laptop and desktop computers.

Allocation of the overall campaign budget and/or campaign impressions between different ads and/or placements can also be supported, as can rotation of ads and/or placements. Furthermore, multiple campaigns can be supported by the same advertiser account and vice versa (i.e., a single campaign supported by multiple advertiser accounts—including both multiple accounts from the same advertiser and accounts from multiple advertisers). Different payment models can also be supported. For example, campaigns can be invoiced rather than paid in advance.

The specific interface also is not required to follow the example shown in FIGS. 2-7. Different interfaces can be used. As an example, a different interface preferably is used for bidding models. For example, the placements could be listed (e.g. a vertical ad on the east side of http://pets.yahoo.com/pets/dogs/breed/sporting) and the advertiser could enter the maximum bid for each page and placement. Alternatively, the advertiser might place a maximum bid to have his ad show on any ad/page combination within the site (or across multiple sites) that are relevant to his business. Relevancy can be defined by the advertiser or determined by the site. As a last example, the platform can also support auction pricing. As a specific example, the site may decide to sell premium inventory by auction—with a defined time limit for expiration, at the end of which the highest bidder will win the inventory being auctioned—a certain amount of impressions or clicks in a specific ad unit on a specific page.

As a final example, alerts and reports are not limited to those discussed in FIGS. 2-7. For example, an alert can be generated when days become available at a price equal to/lower than a limit set by the advertiser. A programmatic interface may be provided to allow the advertiser to request specific types of reports. Many other variations will be apparent.

FIGS. 8-19 describe an example system with a self-service platform. In these diagrams, the same component may be referred to as a module, server or other descriptive term, for example “self-serve billing,” “self-serve billing module,” “self-serve billing server,” or “self-serve billing application.” It should be understood that these components are not meant to be limited to a specific physical form. In most cases, the preferred implementation currently is software. However, depending on the specific application, they can be implemented as hardware, firmware, software, and/or combinations of these. Furthermore, different components can share common sub-components or even be implemented by the same sub-components. There may or may not be a clear boundary between different components.

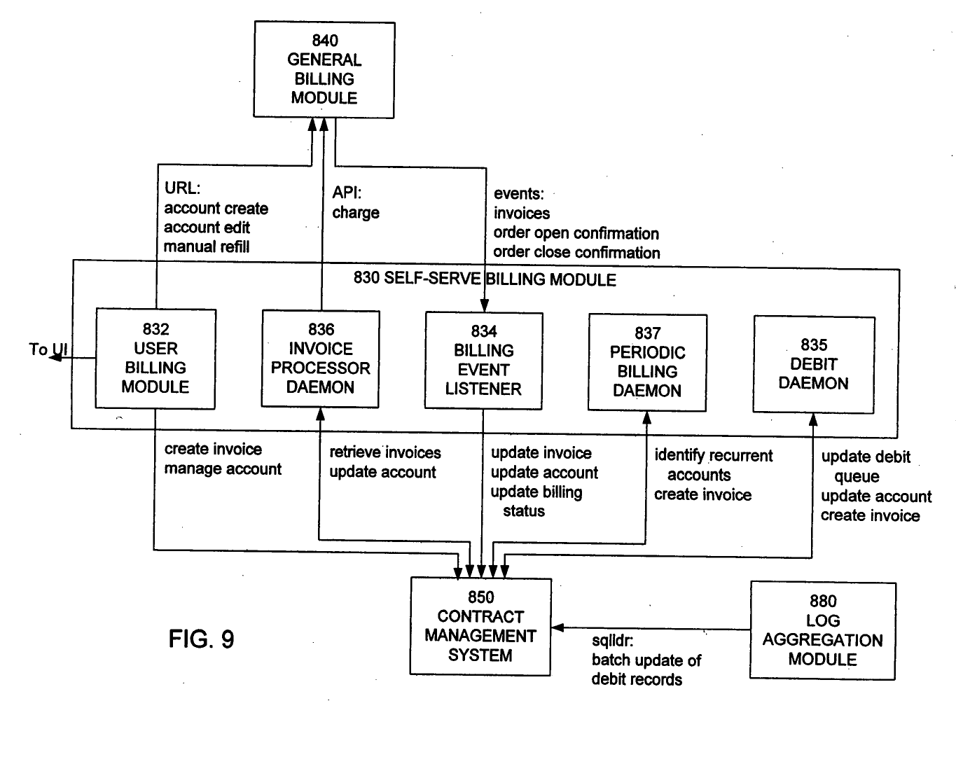

FIGS. 8-13 illustrate different aspects of billing the advertiser. FIG. 8 shows an example billing architecture. In this diagram, the self-serve user interface (UI) 810 includes the interface to the self-service platform which the advertiser uses. The UI includes the pages shown in FIGS. 2-7 above. The wallet module 820 is wallet technology, which will be discussed in the context of funding an account. The self-serve billing module 830 includes aspects of billing that are specific to the self-service platform, as will be further described in FIG. 9. The general billing module 840 includes other parts of the billing infrastructure, including infrastructure that may be used by applications other than the self-service platform. The contract management system 850 manages account information and contracts (i.e., campaigns) for advertisers. It typically includes both databases for storing the information and servers for processing the information. The ad server 860 is responsible for serving ads. In this implementation, the ad server 860 serves ads requested by the corresponding client-side application. The contract management system 850 provides transactional updates to the ad server 860, for example when an advertiser updates his campaign. The ad view server 872 provides search functionality. The redirect server 876 redirects users to the appropriate URL. In this implementation, the ad view server 872 and redirect server 876 also collect and report page views and click-throughs from the sites, respectively. The log aggregation module 880 aggregates view, click and other site data, as will be further described below. The aggregated data is stored in the reports database 885.

The self-serve application interfaces with the general billing module 840 in two ways. The first interface is a UI URL Interface 815 with the ordering servers. The ordering servers are part of the general billing module 840. The UI URL interface 815 supports such operations as account creation (i.e., initial funding of account), account edit (e.g., change of the billing model), and manual refill of the account. The second interface is an API XML interface 835. This interface supports payment operations and purchase status queries, using similar parameters to the UI URL interface 815. The general billing module 840 is the listener, which listens for the request (request/response protocol can be similar to the XML interface in the above UI URL interface).

FIG. 9 is a more detailed diagram and flow description of the self-serve billing module 830. In this diagram, the general billing module 840, contract management system 850, and log aggregation module 880 are the same as in FIG. 8. The rest of the components shown are part of the self-serve billing module 830 of FIG. 8. These include a user billing module 832, billing event listener 834, debit daemon 835, invoice processor daemon 836 and periodic billing daemon 837.

The user billing module 832 handles billing related requests from the self-serve UI 810 (not shown in FIG. 9). This module 832 creates the invoice record and generates the redirect URL for the general billing module 840 (e.g., redirects to jump to order pages on the general billing module 840). The self-serve UI PHP scripts access the user billing module 832 via the PHP extension. Self-serve UI 810 requests that are supported by the user billing module 832 include the following:
Account create—Create an account in billing; perform the initial charge
Account edit—Edit account billing options
Manual refill—Add funds to the account
Promotion—Issue a coupon or promotion credit to the account. In addition, ser Billing 832 will make sure that the promotion code is marked used and cannot be re-used again.

The billing event listener 834 is a billing repl (replication) event consumer module that processes various confirmation events from the general billing module 840, such as Invoice, Open and Close confirmation events.

The log aggregation module 880 runs periodically (e.g., every 15 min). Among other functions, it creates a set of debit files based on the incoming click statistics from the redirect server 876 (assuming for this example that all contracts are CPC-based). These debit files are loaded into the contract management system 850 on a batch basis, thus updating the debit queues in the contract management system 850.

The debit daemon 835 runs periodically and processes the updated debit queues in the contract management system 850. The debit daemon 835 changes the status of different entries in the debit queues are they are processed, updates the advertiser's account as needed (e.g., reducing the account balance to resolve the debit and flagging the account as zero balance if that is the result) and creates invoices if necessary (e.g., at zero balance or if an automatic refill is required).

The periodic billing daemon 837 runs periodically and handles monthly (or other periodic) charges. If an account matches the criteria for a periodic charge, the periodic billing daemon 837 creates a corresponding invoice. This invoice is processed by the invoice processor daemon 836. The general billing module 840 sends a confirmation upon successful charge, which will be processed by the billing event listener module 834 and the account balance will be updated at that time.

The invoice processor daemon 836 runs periodically and processes new invoices, including those for automatic and monthly account types. It reads new unprocessed invoice entries and calls the general billing module 840 API to resolve the invoice. The advertiser's credit card is charged (or other payment options are invoked) and the corresponding account balance is updated. If the billing is unsuccessful, for example due to problems with the account's credit card, then funds are not added to the user's account.

The database schema for this particular example includes the following tables:
Invoice_all: This table contains invoice records for the self-service account
Account_balance: This table contains balance and related information for the self-service account
Debit_transaction_queue: The log aggregator module 880 creates new debit entries in this table, which are then processed by the debit daemon 835
Debit_transaction_history: After debit daemon 835 has processed a debit_transaction_queue entry, it creates a corresponding debit_transaction_history entry in this table. The original queue record is then deleted.
Account_billing_option_history: When the advertiser places a UI request to change account billing options, the user billing module 832 creates a record in this table. When the billing event listener 834 receives the account edit confirmation event, it updates the corresponding entries in the account_balance table.

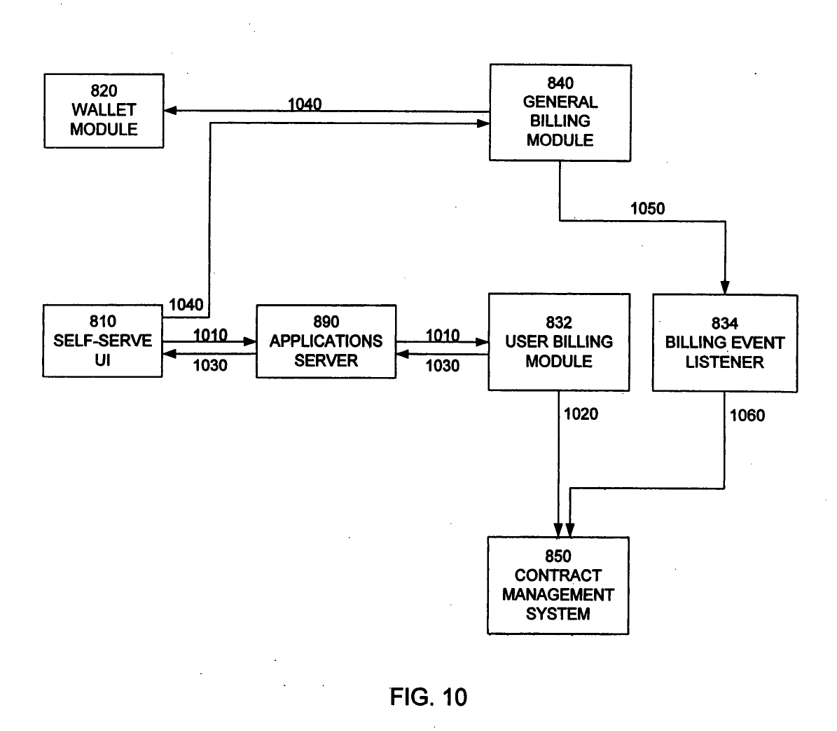

FIGS. 10-13 are data flow diagrams illustrating examples of different types of payments, using the system shown in FIGS. 8-9. FIG. 10 is a data flow diagram illustrating a UI driven one-time payment, for example the initial payment as part of creating an account or a manual refill of an account. In FIG. 10, the applications server 890 is a server that redirects UI requests to the appropriate backend servers. It also contains business logic to serve some requests on its own. The remaining components are the same as in the previous figures.

To set up the account and perform the initial purchase (account create) or perform a subsequent purchase from the UI (manual refill), the self-serve UI 810 sends 1010 a corresponding command to the user billing module 832, via the applications server 890. The user billing module 832 creates 1020 a new invoice record in the invoice_all table. It also forms a redirect URL for the general billing module 840, which will contain all the information required to set up the new account or to perform a purchase, and returns 1030 the URL to the self-serve UI 810.

In the case of manual refill, the user billing module 832 also makes sure the advertiser already has an active self-service order. In the case of account create, the advertiser interacts 1040 with the general billing module 840 to provide required information to perform credit card transaction (name, billing info, expiration date, amount to charge etc). The general billing module 840 creates a purchase record, which can be immediately accessed. The purchase record can also be stored, in order to preserve a record of its occurrence.

The general billing module 840 performs the charge for the specified amount. It generates an invoice event if the charge was successful, which is eventually delivered 1050 to billing event listener 834 via repl connection. The billing event listener 834 updates 1060 the invoice record in the contract management system 850 to indicate the successful charge. If the charge was not successful, no invoice event is generated and the invoice record is not updated. The self-serve UI 810 can access the invoice record, so that it can give user feedback on whether the charge has been successful and/or the new updated account balance.

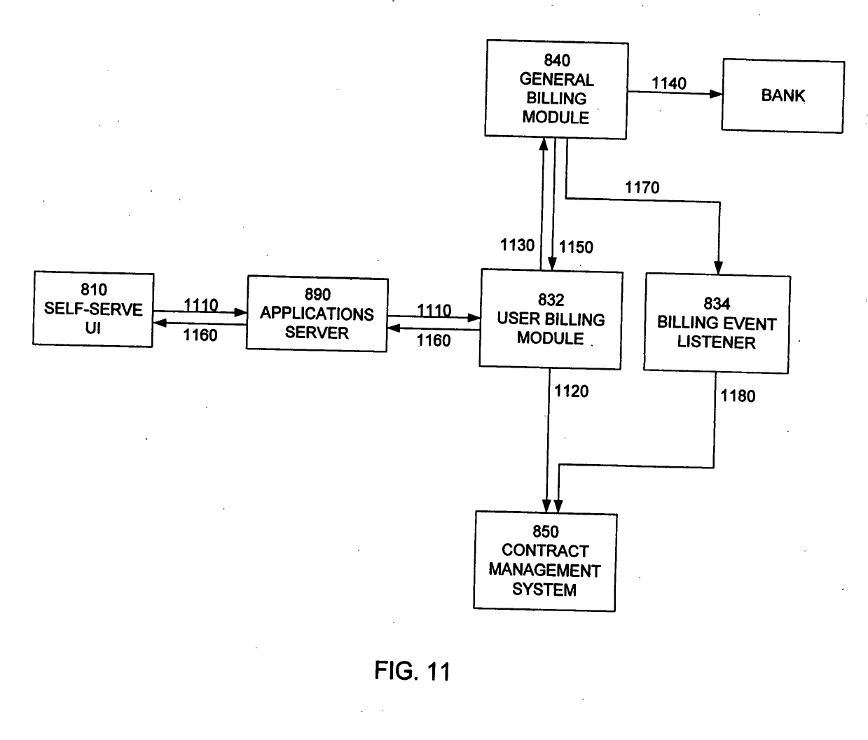

FIG. 11 is a data flow diagram illustrating offline payment via a bank or other financial institution. To set up the account and perform the initial purchase (account create) or to perform a subsequent purchase from the UI (manual refill), the self-serve UI 810 sends 1110 a corresponding command to the user billing module 832. The user billing module 832 creates 1120 a new invoice record in the invoice_all table. It also makes 1130 a UI redirect to the general billing module 840. In the case of account create, the advertiser also provides required information to set up his account (e.g., name, billing info, amount to charge etc).

The general billing module 840 performs the necessary steps to submit 1140 the purchase request to the bank. It also returns 1150 the status and the bank code back to user billing 832 as part of an event. User billing 832 returns 1160 the bank code to the UI 810, so that the advertiser can go to the bank offline to pay. After the offline payment has been processed, the general billing module 840 generates an invoice event, which is processed 1170, 1180 by the billing event listener 834 in the same manner as in FIG. 10 (i.e., steps 1050 and 1060).

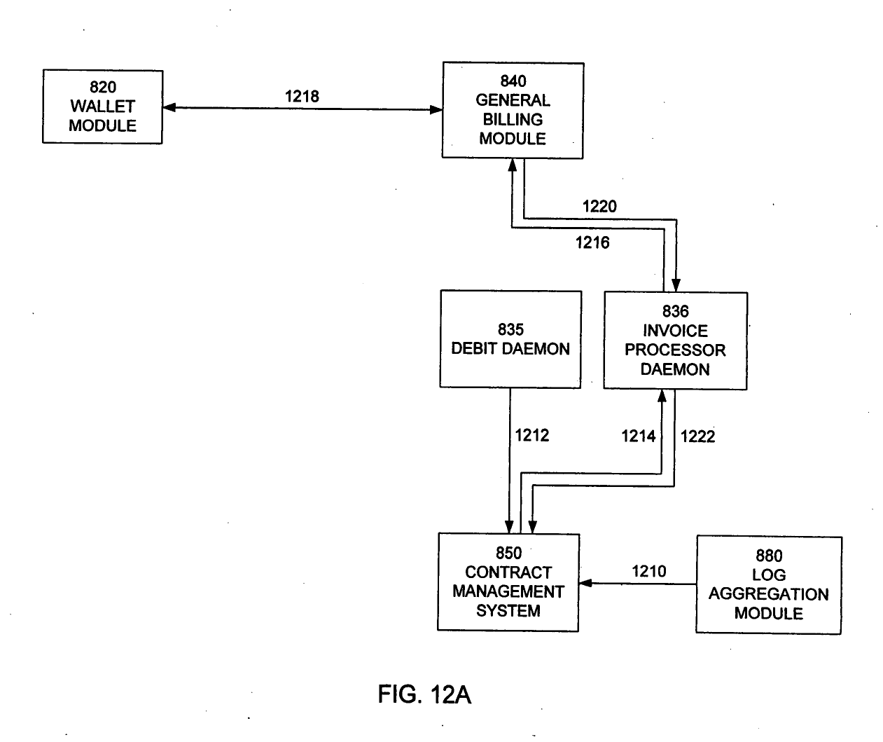

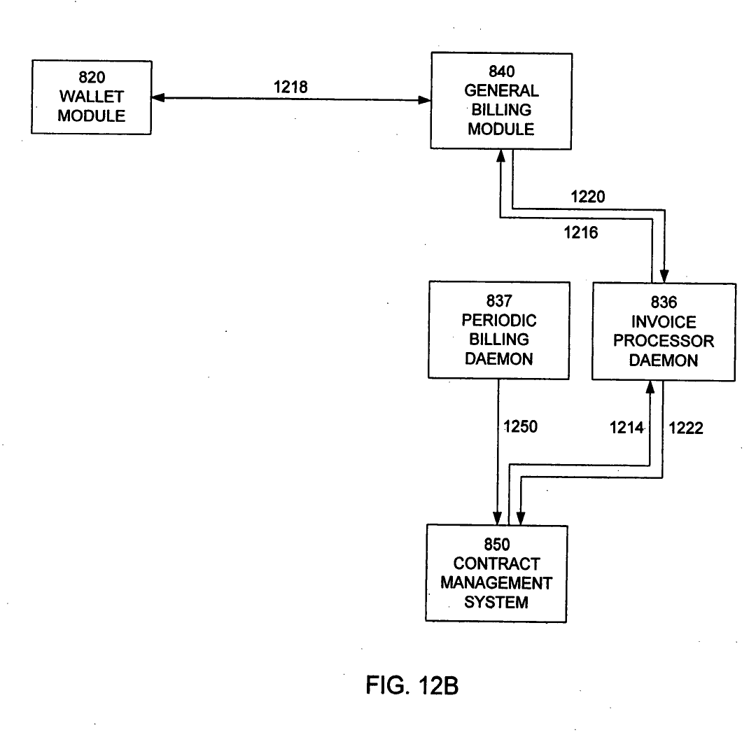

FIGS. 12A-12B are data flow diagrams illustrating credit-card based automatic and monthly refill billing models, respectively. Wallet technology (e.g., express check-out) is preferred for implementing recurrent billing models such as these and is assumed in the following examples, although not required. The self-serve billing module 830 performs provisioning. The general billing module 840 serves as the service provider.

In FIG. 12A, the log aggregation module 880 processes incoming click log data (assuming CPC pricing) and generates 1210 debit entries in the table debit_transaction_queue. The debit daemon 835 processes 1212 these entries. The debit daemon updates account balances and, if the account balance falls below the level for automatic refilling, an invoice is generated for refilling. The invoice processor daemon 836 retrieves 1214 these invoices and generates 1216 a charge XML API call to the general billing module 840. The general billing module 840 accesses 1218 the credit card information from the wallet module 820, performs the credit card charge and returns 1220 the processing status. The invoice processor daemon 836 updates 1222 the invoice status.

In FIG. 12B, the periodic billing daemon 837 periodically retrieves the accounts that are due for periodic refill and creates 1250 the corresponding invoices. The remaining steps are the same as in FIG. 12A. The invoice processor daemon 836 retrieves 1214 these invoices and generates 1216 a charge XML API call to the general billing module 840. The general billing module 840 accesses 1218 the credit card information from the wallet module 820, performs the credit card charge and returns 1220 the processing status. The invoice processor daemon 836 updates 1222 the invoice status.

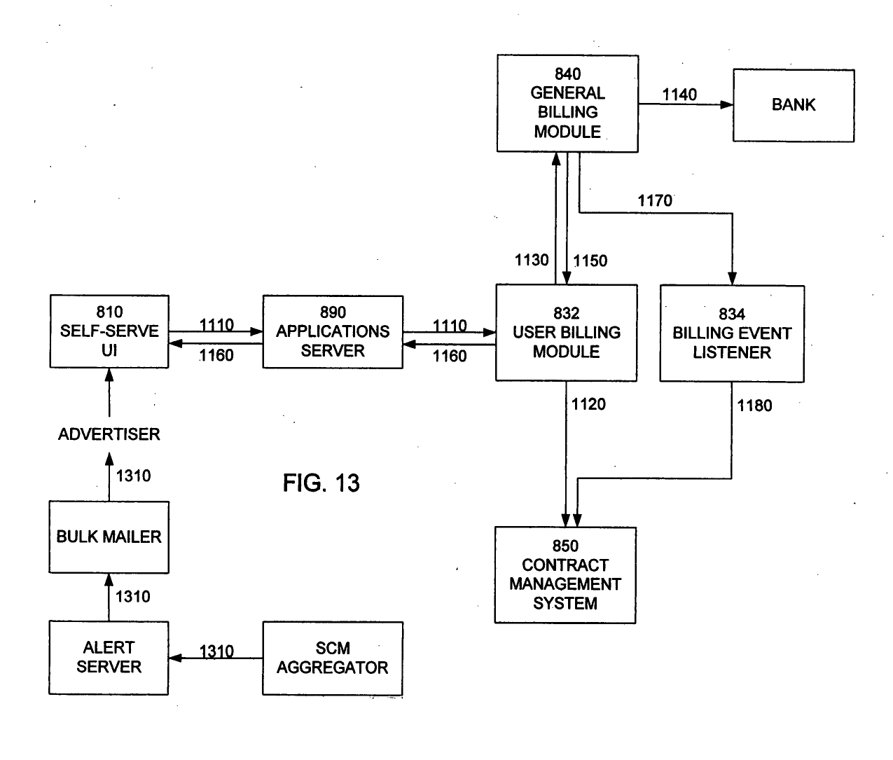

FIG. 13 is a data flow diagram illustrating a recurrent billing model based on offline payments. When a refill is appropriate, the advertiser's account is not charged automatically. Rather, the system generates 1310 a UI and an email alert to the advertiser that his account balance is low and the account may become inactive if funds are not added. The advertiser should come to the self-serve application to complete manual payment. The remainder of the process is the same as in FIG. 11.

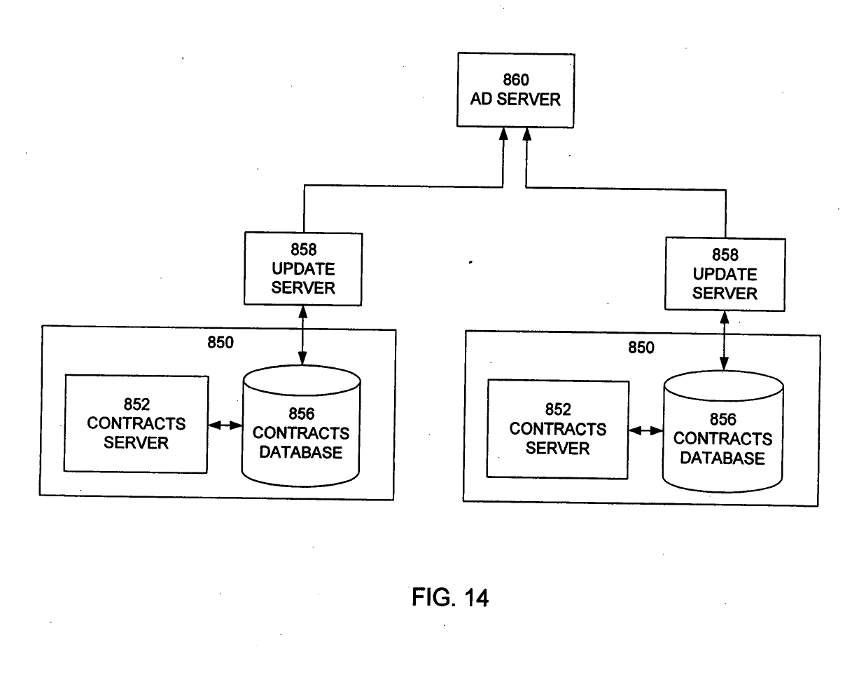

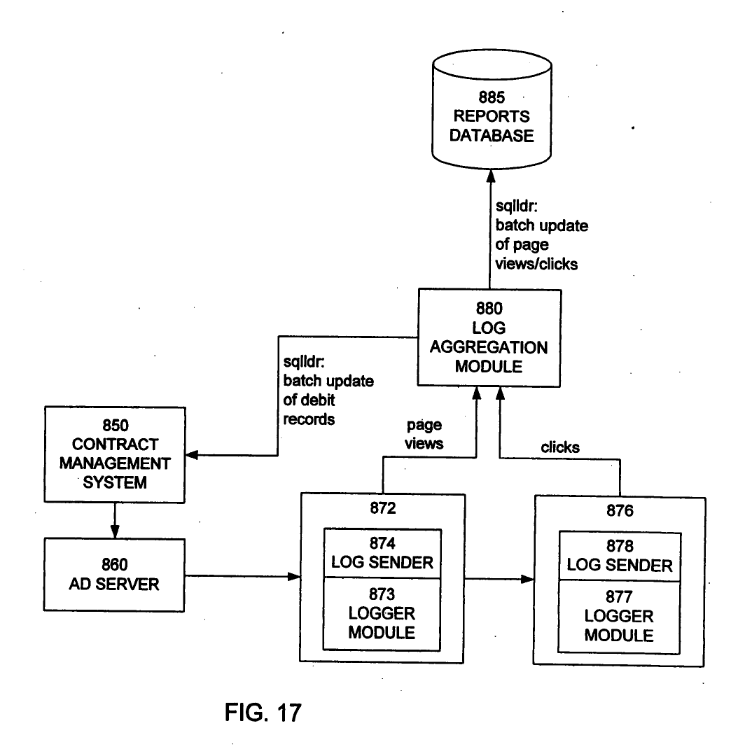

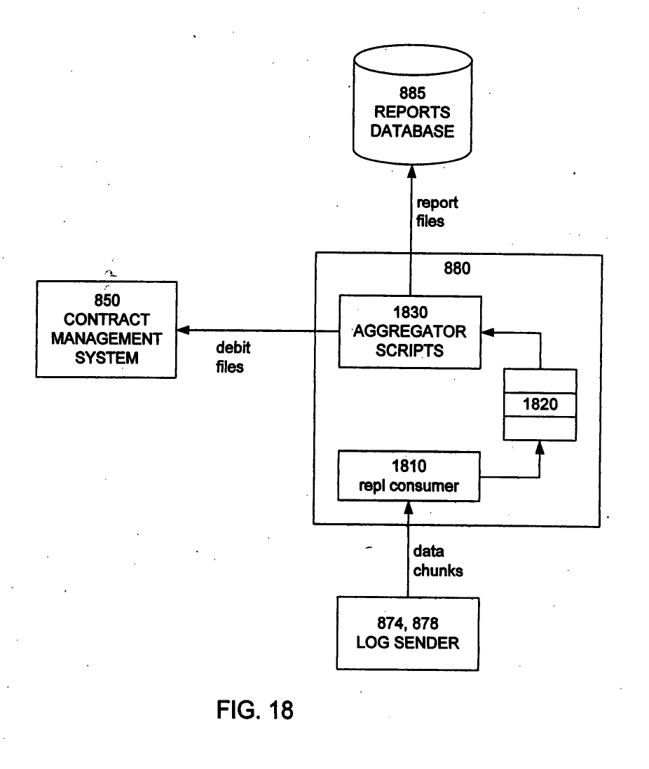

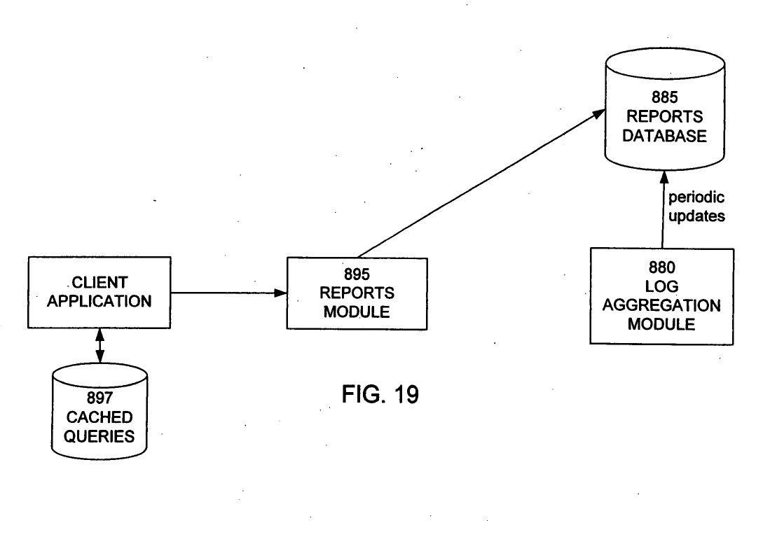

FIGS. 14-19 illustrate other aspects of this system, continuing the specific example of FIGS. 2-13. In particular, FIGS. 14-16 concern transactional updates to the ad server 860. FIGS. 17-18 concern log aggregation. FIG. 19 concerns reporting.

Referring to FIG. 8, the contract management system 850 maintains a database of information about campaigns and provides transactional updates to ad server 860, for example when an advertiser updates his campaign. FIG. 14 is a block diagram of a portion of the overall system that accomplishes this. The contract management system 850 in FIG. 8 is shown as a contracts server 852 coupled to a contracts database 856. The update server 858 (not shown in FIG. 8) provides the transactional updates.

The update servers 858 support both individual operations (e.g., from end users) and batch updates. As a result, the contract server 852 API call is selected as the transaction boundary. If a contract server API call corresponds to a contract update that should also go to the ad server 860, it will generate a message in the update server 860's transaction queue. The handling of each message becomes an update server transaction. These transactions are not triggered by event. Instead, messages are picked up by a consumer of the message queue, which keeps running no matter what messages are in the queue.

To provide more flexibility between the data calculation and command transmission, they are separated into two asynchronous threads: transaction processor and transmitter. Transmitter is responsible for sending commands to the ad server 860, recording errors and history records. With this mechanism, a problem with the ad server 860 will not affect the calculation of new data updates on the contract management system side of things. It can also work as a “backdoor” through which manual data push to the ad server 860 is possible in case of debugging and urgent request handling.

Batch update requests are broken down to a list of separate transactions before reaching the update server 860. These transactions share the same priority and same queue as non-batch transactions. There is no need to differentiate batch transactions from non-batch transactions. In this way, the update server 860 can handle both batch and non-batch updates.

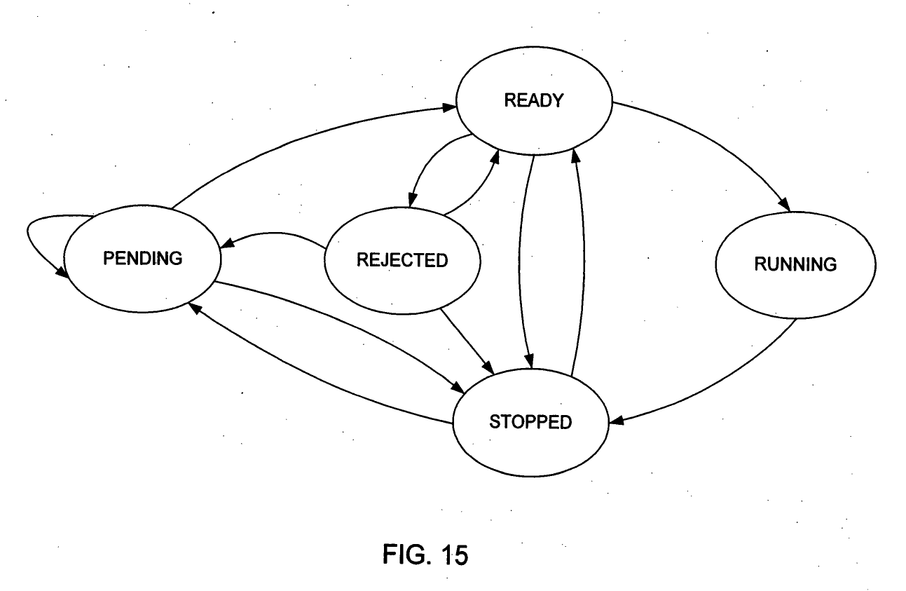

FIG. 15 shows a state diagram for line status transitions. In this example, a line is an ad with attached criteria (such as CTR, eCPM, etc.). The ad server 860 apportions delivery of impressions to lines based on competitive criteria (e.g., on the basis of eCPM). The line status transitions of FIG. 15 are described below:
Pending->Ready: when a line is approved by a reviewer
Ready->Running: when a line's complete schedule data matches the current date and the account is active (ie funds are available)
Running->Stopped: when a line is stopped by an advertiser/reviewer or auto stopped by schedule
Stopped->Ready: when a line is reactivated by schedule (no data change) or when the account status changes from inactive to active
Stopped->Pending: when a line is edited by advertiser (may involve data change)
Any state->Stopped: when a line is stopped by advertiser or when the account becomes inactive
Ready->Rejected: when the reviewer rejects a line
Rejected->Ready: when the reviewer approves the new data
Rejected->Pending: when advertiser makes data update on a Rejected line
Pending->Pending: when advertiser makes data update on a Pending line
   The content management system 850 is responsible for updating line status.

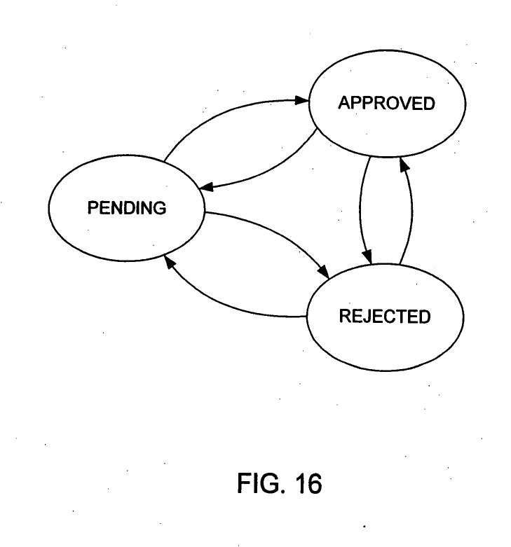

FIG. 16 shows a state diagram for ad status transitions, as described below:
Pending->Approved: when reviewer approves the ad
Pending->Rejected: when reviewer rejects the ad
Rejected->Pending: when advertiser updates a Rejected ad
Rejected->Approved: when reviewer revokes his/her disapproval
Approved->Rejected: when reviewer revokes his/her approval and rejects the ad
Approved->Pending: when reviewer revokes his/her approval or advertiser updates an Approved ad
   Approved is a final status because the contract management system 850 uses two tables for ads: Pendingads and Ads. Ads only contain those that have been approved. Once a pending ad is approved and replaces an existing ad, the existing ad will only be available in the History tables and will not be easy to retrieve. The Rejected state in FIG. 16 corresponds to the Declined status in FIG. 6E.

Turning now to log aggregation, FIG. 17 shows further details of the log aggregation portion of FIG. 8. FIG. 18 shows details of the log aggregation module 880 in FIG. 17.

As shown in FIG. 17, the ad view server 872 and redirect server 876 each include Apache logger modules 873, 877 and log senders 874, 878. The Apache logger module 873 logs what ads have been displayed to users (i.e. “ad views”). When the user clicks on an ad link, the redirect server 876 receives a request and redirects the user to the location specified in the ad URL. The clicked (redirected) ads (i.e. “ad clicks”) are logged by Apache logger module 877. Periodically (e.g., every 5 minutes), the log sender daemon processes 874, 878 run on the ad view server 872 and redirect server 876. The log senders 874, 878 deliver a log data chunk which contains ad view and/or ad click data for the last time period to the log aggregation module 880 for processing. The log senders 874, 878 and the log aggregation module 880 communicate via the repl connection.

Referring to FIG. 18, the repl consumer library 1810 in the log aggregator module 880 stores the incoming log data chunks as chunk files 1820 for subsequent processing. In this implementation, the chunk files 1820 are processed periodically in batch mode by aggregator scripts 1830. Some information (e.g., views and clicks stats) is loaded into the reports database 885 (e.g., for user reports). Some information (e.g., debit records) is loaded into the contract management system 850, for example for debit processing.

FIG. 19 shows further details on the reporting function in FIG. 8. The reports module 895 provides report data used in the customer front-end. In this example, the reports module 895 is implemented as part of the application server 890 in FIG. 10. In this implementation, reports module 895 includes a query server that provides three different types of queries into the reports database 885: regular SQL query, cached query, and composite query. All the queries are subclassed from the same general query class, which exports the same query interface to the client.

Cached query increases performance and scalability. They can be used when several same report requests are received from the client during a short period of time (e.g., between database updates). For example, some reports may include a large number of rows of data and hence use pagination. In one implementation, this information is cached as queries in the MYSQL database 897. Cached query thus avoids multiple server round trips when navigating between pages. This cache 897 also supports sorting of columns in a tabular display of data.

Report data query exports an API that takes parameter/value pairs and a report name and generates a report table. The report name is mapped to the stored SQL query(s), which are then used to query the database or a cache. Therefore, no recompilation of the module is required when a new report is added, only the change to the configuration file that stores the mapping between the report name and an SQL query.

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents. Furthermore, no element, component or method step is intended to be dedicated to the public regardless of whether the element, component or method step is explicitly recited in the claims.

1-48. (Cancelled)

49. A method comprising:
(A) receiving a request, over the Internet, to initiate an advertisement campaign, the request comprising:
a maximum amount to spend on the advertisement campaign,
a designation of an advertisement to be used in the advertisement campaign, and
a time period in which the advertisement is to be run;
(B) reviewing the advertisement, and,
when the advertisement is deemed not approved, the advertisement campaign is rejected, and
when the advertisement is deemed approved, the advertisement campaign is accepted; and
(C) displaying the advertisement during said time period when the advertisement campaign is accepted.

50. The method of claim 49 wherein said displaying comprises posting said advertisement to a predetermined URL or a URL specified by said request during said time period.

51. The method of claim 49 wherein said displaying comprising displaying said advertisement on a predetermined wireless device or on a wireless device specified by said request during said time period.

52. The method of claim 49 wherein the receiving further comprises:
providing a plurality of template advertisements;
obtaining a selection of a template advertisement in said plurality of template advertisements;
obtaining information to be inserted into the template advertisement; and
creating the advertisement designated by the request based on the template advertisement and the information to be inserted into the template advertisement.

53. The method of claim 52, the method further comprising:
providing a preview of the advertisement designated by the request.

54. The method of claim 49, wherein the receiving further comprises:
providing a plurality of time periods that are available for the advertisement; and
accepting a selection of a time period in the plurality of time periods to run the advertisement.

55. The method of claim 49, wherein the advertisement campaign comprises a plurality of advertisements, the method further comprising:
providing an image of each advertisement in the plurality of advertisements in the advertisement campaign; and
receiving instructions to edit the plurality of advertisements.

56. The method of claim 55 wherein the instructions to edit the plurality of advertisements modify:
which advertisements are part of the plurality of advertisements,
a web page that an advertisement in the plurality of advertisements is posted to when the advertisement is run; or
a time period in which an advertisement in the plurality of advertisements is run on a web site.

57. The method of claim 49 the method further comprising:
displaying a summary of a plurality of advertising campaigns, each respective advertisement campaign in the plurality of advertising campaigns defining:
a maximum amount to spend on the respective advertisement campaign,
a designation of one or more advertisements to be used in the respective advertisement campaign, and
a time period in which an advertisement in the respective advertisement campaign is to be run.

58. The method of claim 57 wherein a first advertising campaign in the plurality of advertising campaigns has a status and the step of displaying a summary of the plurality of advertising campaigns comprises displaying the status of the first advertising campaign; and wherein the method further comprises
receiving instructions to change the status of the first advertising campaign from a first state to a second state.

59. The method of claim 58 wherein the first state and the second state are each independently an active state, a suspended state, or a cancelled state, wherein
when said state of said first advertising campaign is the active state, the one or more advertisements specified by the first advertisement campaign are run on a predetermined web site or on a web site specified by the advertising campaign;
when said state of said first advertising campaign is the suspended state, the one or more advertisements specified by the first advertisement campaign are not run on a predetermined web site or on a web site specified by the advertising campaign; and
when said state of said first advertising campaign is the cancelled state, the first advertisement campaign is removed from the plurality of advertising campaigns.

60. The method of claim 49 wherein a cost for said advertisement campaign is set by a time that the request is received.

61. The method of claim 49 wherein the advertisement is displayed on a predetermined web site or on a web site specified by the request as a function of the relevancy of the advertisement.

62. The method of claim 61 wherein the relevancy of the advertisement is measured at least in part by a financial metric.

63. The method of claim 62 wherein the financial metric is the effective cost per Mil (eCPM) for the advertisement.

64. The method of claim 61 wherein the relevancy of the advertisement is measured at least in part by a contextual relevancy of the advertisement to other content on a predetermined web site or a web site specified by the request.

65. The method of claim 49 wherein said displaying (C) further comprises:
computing an effective cost per Mil (eCPM) for the advertisement; and
displaying said advertisement on a predetermined web site or a web site specified by said request during said time period when the eCPM for the advertisement exceeds the eCPM of another advertisement that is designated for placement on said predetermined web site or the web site specified by said request.

66. The method of claim 49 wherein said advertisement is (i) text only, (ii) text and a URL link, (iii) an icon and a URL link, (iv) a banner ad, (v) a graphic, or (vi) a video.

67. A computer comprising:
a self-serve user interface comprising:
instructions for receiving a request, over the Internet, to initiate an advertisement campaign, the request comprising:
a maximum amount to spend on the advertisement campaign,
a designation of an advertisement to be used in the advertisement campaign, and
a time period in which the advertisement is to be run;
instructions for reviewing the advertisement, and,
when the advertisement is deemed not approved, the advertisement campaign is rejected, and
when the advertisement is deemed approved, the advertisement campaign is accepted; and
instructions for displaying said advertisement, when the advertisement campaign is accepted, during said time period.

68. The computer of claim 67, further comprising:
a self-serve billing module coupled to the self-serve user interface for billing the originator of the request when the advertisement is displayed on the predetermined web site or on the web site specified by said request order.

69. The computer of claim 68, further comprising:
a back-end system coupled to the self-serve billing module, the back-end system comprising:
a contract management system for managing information about the request; and
an advertisement server coupled to the contract management system for serving advertisements to the predetermined web site on the web site specified by the request.

70. The computer of claim 69, wherein the back-end system further comprises:
a log aggregation module coupled to the contract management system for aggregating data about advertisement serves and providing updates of such data to the contract management system.

71. The computer of claim 67 wherein said instructions for displaying comprise displaying said advertisement on a predetermined web site or on a web site specified by said request during said time period.

72. The computer of claim 71 wherein said predetermined web site or said web site specified by said request on which said advertisement is displayed is served to a remote computer that displays said web site in an Internet browser running on said remote computer.

73. The computer of claim 67 wherein said instructions for displaying comprise displaying said advertisement on a predetermined wireless device or on a wireless device specified by said request during said time period.

74. The computer of claim 67, wherein the instructions for receiving further comprise:
instructions for providing a plurality of template advertisements;
instructions obtaining a selection of a template advertisement in said plurality of template advertisements;
instructions for obtaining information to be inserted into the template advertisement; and
instructions for creating the advertisement designated by the request based on the template advertisement and the information to be inserted into the template advertisement.

75. The computer of claim 74, further comprising:
instructions for transmitting a preview of the advertisement designated by the request.

76. The computer of claim 75 wherein said preview is displayed on a remote computer.

77. The computer of claim 67, wherein the instructions for receiving further comprise:
instructions for providing a plurality of time periods that are available for the advertisement; and
instructions for obtaining a selection of a time period in the plurality of time periods to run the advertisement.

78. The computer of claim 67, wherein the advertisement campaign comprises a plurality of advertisements, the computer further comprising:
instructions for transmitting an image of each advertisement in the plurality of advertisements in the advertisement campaign; and
instructions for receiving instructions to edit the plurality of advertisements.

79. The computer of claim 78 wherein the image of each advertisement in the plurality of advertisements in the advertisement campaign is displayed on a remote computer.

80. The computer of claim 78 wherein the instructions to edit the plurality of advertisement modify:
which advertisements are part of the plurality of advertisements,
a web page that an advertisement in the plurality of advertisements is posted to when the advertisement is run; or
a time period in which an advertisement in the plurality of advertisements is run on a web site.

81. The computer of claim 67, further comprising:
instructions for communicating a summary of a plurality of advertising campaigns, each respective advertisement campaign in the plurality of advertising campaigns defining:
a maximum amount to spend on the respective advertisement campaign,
a designation of one or more advertisements to be used in the respective advertisement campaign, and
a time period in which an advertisement in the respective advertisement campaign is to be run.

82. The computer of claim 81 wherein a first advertising campaign in the plurality of advertising campaigns has a status and the step of communicating a summary of the plurality of advertising campaigns comprises indicating the status of the first advertising campaign; and wherein the computer further comprises instructions for receiving instructions to change the status of the first advertising campaign from a first state to a second state.

83. The computer of claim 82, wherein the first state and the second state are each independently an active state, a suspended state, or a cancelled state, wherein
when said state of said first advertising campaign is the active state, the one or more advertisements specified by the first advertisement campaign are run on a predetermined web site or on a web site specified by the advertising campaign;
when said state of said first advertising campaign is the suspended state, the one or more advertisements specified by the first advertisement campaign are not run on a predetermined web site or on a web site specified by the advertising campaign; and
when said state of said first advertising campaign is the cancelled state, the first advertisement campaign is removed from the plurality of advertising campaigns.

84. The computer of claim 67 wherein a cost for said advertisement campaign is set by a time that the request is received by said computer.

85. The computer of claim 67 wherein the advertisement is displayed on a predetermined web site or on a web site specified by the request as a function of the relevancy of the advertisement.

86. The computer of claim 85 wherein the relevancy of the advertisement is measured at least in part by a financial metric.

87. The computer of claim 86 wherein the financial metric is the effective cost per Mil (eCPM) for the advertisement.

88. The computer of claim 85 wherein the relevancy of the advertisement is measured at least in part by a contextual relevancy of the advertisement to other content on a predetermined web site or a web site specified by the request.

89. The computer of claim 67 wherein said instructions for displaying further comprises:
instructions for computing an effective cost per Mil (eCPM) for the advertisement; and
instructions for displaying said advertisement on a predetermined web site or a web site specified by said request during said time period when the eCPM for the advertisement exceeds the eCPM of another advertisement that is designated for placement on said predetermined web site or the web site specified by said request.

90. The computer of claim 67 wherein said advertisement is (i) text only, (ii) text and a URL link, (iii) an icon and a URL link, (iv) a banner ad, (v) a graphic, or (vi) a video.

91. The computer of claim 67 wherein said instructions for displaying said advertisement, when the advertisement campaign is accepted, during said time period comprise:
instructions for incorporating said advertisement into a web page; and
instructions for serving said web page at a predetermined URL or at a URL specified by said request.

92. A computer program product for use in conjunction with a computer system, the computer program product comprising a computer readable storage medium and a computer program mechanism embedded therein, the computer program mechanism comprising:
instructions for receiving a request, over the Internet, to initiate an advertisement campaign, the request comprising:
a maximum amount to spend on the advertisement campaign,
a designation of an advertisement to be used in the advertisement campaign, and
a time period in which the advertisement is to be run;
instructions for reviewing the advertisement, and,
when the advertisement is deemed not approved, the advertisement campaign is rejected, and
when the advertisement is deemed approved, the advertisement campaign is accepted; and
instructions for incorporating said advertisement, when the advertisement campaign is accepted, into a web page.

93. The computer program product of claim 92, wherein the computer readable mechanism further comprises:
instructions for hosting said web page on a predetermined URL or a URL specified by said request.

94. The computer program product of claim 92, wherein the computer readable mechanism further comprises:
instructions for transmitting said web page to a predetermined wireless device or a wireless device specified by said request.
